(19) United States
(12) Patent Application Publication
(10) Pub. No.: US 2026/0329222 A1
(43) Pub. Date: Oct. 22, 2026

(54) IMAGE FORMING APPARATUS

(71) Applicant: CANON KABUSHIKI KAISHA, Tokyo (JP)

(72) Inventor: KAZUHIKO AONO, Shizuoka (JP)

(21) Appl. No.: 19/559,299

(22) Filed: Mar. 6, 2026

(30) Foreign Application Priority Data
Apr. 17, 2025 (JP) 2025-068392

(51) Int. Cl. G03G 21/16; F16B 37/04; G03G 15/00

(52) U.S. Cl. CPC G03G 21/1647; F16B 37/041; G03G 15/6502; G03G 21/1619

(57) ABSTRACT

An image forming system includes an image forming apparatus, a sheet conveying apparatus, a nut and a bolt. The image forming apparatus includes a first feeder in which a first through hole is formed. The sheet conveying apparatus includes an accommodated portion to be accommodated inside the first feeder and to include a second feeder for accommodating the nut thereinside. The bolt is engaged with the nut in a state in which the bolt is inserted into both the first through hole and a second through hole formed in the accommodated portion. A downstream end of the second feeder forms an opening in a penetration direction. The opening is formed so that the nut is attachable to and detachable from the opening in a case that engagement of the nut and the bolt is released and connection of the image forming apparatus and the sheet conveying apparatus is released.

### BACKGROUND

### Field of the Technology

The present disclosure relates to an image forming system for forming an image on a sheet.

### Description of the Related Art

The image forming system, which is provided with an image forming apparatus for forming the image on the sheet and a sheet conveying apparatus which is connected to the image forming apparatus for conveying the sheet, has been known. As a configuration for connecting the image forming apparatus and the sheet conveying apparatus, for example, in a case of applying a bolt and a nut, a configuration in which one of the apparatuses is provided with an accommodating portion for accommodating the nut (see Japanese Laid-Open Patent Application (JP-A) 2023-18975). In the configuration, the nut is attachable to and detachable from the accommodating portion in a direction which is perpendicular to an axis of the bolt.

### SUMMARY

However, in the configuration which is described in JP-A 2023-18975, since the nut must be attached to or detached from the accommodating portion through an opening which is opened in a direction which is perpendicular to a holding portion, there is an issue that replacing the nut may not be easy. The issue may similarly be occurred not only in a fastening configuration which uses the bolt, but also in a press fitting configuration which is comprised of a member which includes a through hole and a shaft member which is pressed and fitted into the through hole.

An object of the present disclosure is to make it possible to easily replace the nut from the accommodating portion.

According to an aspect of the present disclosure, there is provided an image forming system comprising: an image forming apparatus; a sheet conveying apparatus to be connected to the image forming apparatus; a nut; and an engaging member to be engaged with the nut; wherein the image forming apparatus is provided with a first accommodating portion in which a first through hole is formed, wherein the sheet conveying apparatus is provided with an accommodated portion configured to be accommodated inside the first accommodating portion and to include a second accommodating portion for accommodating the nut thereinside, wherein the engaging member is engaged with the nut in a state in which the engaging member is inserted into both the first through hole and a second through hole formed in the accommodated portion, wherein a downstream end of the second accommodating portion forms an opening in a penetration direction from the first through hole toward the second through hole, and wherein the opening is formed so that the nut is attachable to and detachable from the opening in a case in which engagement of the nut and the engaging member is released and connection of the image forming apparatus and the sheet conveying apparatus is released.

Features of the present disclosure will become apparent from the following description of embodiments with reference to the attached drawings. The following description of embodiments is described by way of example.

### BRIEF DESCRIPTION OF THE DRAWINGS

Part (a) of FIG. 1 is a sectional view showing an image forming system according to a first embodiment, and part (b) of FIG. 1 is a front view showing a nut accommodating portion and a nut as viewed from a downstream side in a penetration direction.

FIG. 2 is a perspective view of an image forming apparatus according to the first embodiment as viewed from below.

FIG. 3 is a perspective view of a first feeding apparatus according to the first embodiment as viewed from below.

FIG. 4 is a perspective view of the first feeding apparatus according to the first embodiment as viewed from above.

Part (a), part (b), and part (c) of FIG. 5 are perspective views of a top surface protruding portion of the first feeding apparatus according to the first embodiment, as viewed from an inside of the first feeding apparatus. Part (a) of FIG. 5 is a view showing the top surface protruding portion of the first feeding apparatus alone, part (b) of FIG. 5 is a view showing a state before the nut is accommodated in the top surface protruding portion of the first feeding apparatus, and part (c) of FIG. 5 is a view showing a state after the nut is accommodated in the top surface protruding portion of the first feeding apparatus.

Part (a), part (b), and part (c) of FIG. 6 are perspective views as viewed from above, when the image forming apparatus according to the first embodiment is mounted on an upper portion of the first feeding apparatus. Part (a) of FIG. 6 shows a state before the image forming apparatus is mounted on the upper portion of the first feeding apparatus, part (b) of FIG. 6 shows a state after the image forming apparatus is mounted on the upper portion of the first feeding apparatus and before bolts are screwed, and part (c) of FIG. 6 shows a state while the image forming apparatus and the first feeding apparatus are fastened together by the bolts.

Part (a), part (b), and part (c) of FIG. 7 are sectional views in a vicinity of the top surface protruding portion, while mounting the image forming apparatus according to the first embodiment on the upper portion of the first feeding apparatus. Part (a) of FIG. 7 shows a state before the image forming apparatus is mounted on the upper portion of the first feeding apparatus, part (b) of FIG. 7 shows a state while the image forming apparatus is mounted on the upper portion of the first feeding apparatus, and part (c) of FIG. 7 shows a state while the image forming apparatus and the first feeding apparatus are fastened together by the bolts.

Part (a), part (b), and part (c) of FIG. 8 are perspective views as viewed from above, when the first feeding apparatus according to a second embodiment is mounted on an upper portion of a second feeding apparatus. Part (a) of FIG. 8 shows a state before the first feeding apparatus is mounted on the upper portion of the second feeding apparatus, part (b) of FIG. 8 shows a state after the first feeding apparatus is mounted on the upper portion of the second feeding apparatus and before the bolts are screwed, and part (c) of FIG. 8 shows a state while the first feeding apparatus and the second feeding apparatus are fastened together by the bolts.

Part (a), part (b), and part (c) of FIG. 9 are perspective views of the top surface protruding portion of the first feeding apparatus according to a third embodiment, as viewed from an inside of the first feeding apparatus. Part (a) of FIG. 9 is a view showing the top surface protruding portion of the first feeding apparatus alone, part (b) of FIG. 9 is a view showing a state before a cylindrical member is accommodated in the top surface protruding portion, part (c) of FIG. 9 a view showing a state that the cylindrical member is accommodated in the top surface protruding portion.

Part (a), part (b), and part (c) of FIG. 10 are sectional views in a vicinity of the top surface protruding portion, while mounting the image forming apparatus according to the third embodiment on the upper portion of the first feeding apparatus. Part (a) of FIG. 10 shows a state of the first feeding apparatus before the image forming apparatus is mounted, part (b) of FIG. 10 shows a state while the image forming apparatus is mounted on the upper portion of the first feeding apparatus, and part (c) of FIG. 10 shows a state while the image forming apparatus and the first feeding apparatus are connected by a pin member.

Part (a), part (b), and part (c) of FIG. 11 are perspective views of the top surface protruding portion of the first feeding apparatus according to a fourth embodiment, as viewed from the inside of the first feeding apparatus. Part (a) of FIG. 11 is a view showing the top surface protruding portion of the first feeding apparatus alone, part (b) of FIG. 11 a view showing a state before the nut is accommodated in the top surface protruding portion, and part (c) of FIG. 11 a view showing a state while the nut is accommodated in the top surface protruding portion.

Part (a), part (b), and part (c) of FIG. 12 are sectional views in the vicinity of the top surface protruding portion, while mounting the image forming apparatus according to the fourth embodiment on the upper portion of the first feeding apparatus. Part (a) of FIG. 12 shows a state before the image forming apparatus is mounted on the upper portion of the first feeding apparatus, part (b) of FIG. 12 shows a state while the image forming apparatus is mounted on the upper portion of the first feeding apparatus, and part (c) of FIG. 12 shows a state while the image forming apparatus and the first feeding apparatus are fastened together by the bolts.

FIG. 13 is a perspective view of a main assembly frame member according to a fifth embodiment, as viewed from an upper rear side.

Part (a), part (b), and part (c) of FIG. 14 are perspective views of a rear surface protruding portion of the main assembly frame member according to the fifth embodiment, as viewed from an inside of the main assembly frame member. Part (a) of FIG. 14 is a view showing the rear surface protruding portion of the main assembly frame member alone, part (b) of FIG. 14 a view showing a state before the nut is accommodated in the rear surface protruding portion of the main assembly frame member, and part (c) of FIG. 14 a view showing a state while the nut is accommodated in the rear surface protruding portion of the main assembly frame member.

Part (a), part (b), and part (c) of FIG. 15 are perspective views of a fixing unit according to the fifth embodiment while mounting onto the main assembly frame member, as viewed from an upper rear side. Part (a) of FIG. 15 shows a state before the fixing unit is mounted on a rear portion of the main assembly frame member, part (b) of FIG. 15 shows a state after the fixing unit is mounted on the rear portion of the main assembly frame member and before the bolts are screwed, and part (c) of FIG. 15 shows a state while the fixing unit and the main assembly frame member are fastened together by the bolts.

### DESCRIPTION OF THE EMBODIMENTS

### First embodiment

In the following, a first embodiment of the present disclosure will be specifically described with reference to from part (a) of FIG. 1 through part (c) of FIG. 7. First of all, a schematic configuration of an image forming system 300 according to the embodiment will be described by using part (a) of FIG. 1. Dimensions, materials, relative positions, etc. of component parts of the image forming system 300 may be appropriately changed according to a configuration of an apparatus to which the present disclosure applies and various conditions. Accordingly, unless otherwise specifically described, a scope of the present disclosure is not intended to be limited to these only.

Part (a) of FIG. 1 is a schematic diagram of the image forming system 300 according to the embodiment. The image forming system 300 includes an image forming apparatus 1, a first feeding apparatus 100, and a second feeding apparatus 200. In the embodiment, the first feeding apparatus 100 is an example of a sheet conveying apparatus which is connected to the image forming apparatus 1. In part (a) of FIG. 1, a laser beam printer as an example of the image forming apparatus 1 is shown. Further, in the embodiment, a front-back direction of the image forming system 300 is defined as a X direction (forward direction is positive), a left-right direction of the image forming system 300 is defined as a Y direction, and an up-down direction of the image forming system 300 is defined as a Z direction (upward direction is positive).

### Image forming apparatus

The image forming apparatus 1 includes a main assembly frame member 30, a process cartridge 6 which is integrally attachable to and detachable from the main assembly frame member 30, a transfer roller 9, and a scanner unit 7, etc. The process cartridge 6 is an example of an image forming portion which forms an image on a sheet S, and includes a photosensitive drum 8, a charging member 80, and a developing member 81, etc. The photosensitive drum 8 is a drum-shaped electrophotographic photosensitive member as an image bearing member, and is configured so that photosensitive material such as OPC (Organic Photo Conductor), amorphous selenium, or amorphous silicon is provided on a cylindrical drum base which is formed of aluminum, and nickel, etc. The photosensitive drum 8 is rotatably supported in the process cartridge 6 and is rotationally driven at a predetermined process speed by a driving source which is not shown. The charging member 80, the developing member 81, and the transfer roller 9 which is a transfer member, are disposed sequentially along a rotational direction about the photosensitive drum 8. The scanner unit 7 is an exposure means and is disposed above the photosensitive drum 8.

The image forming apparatus 1 is provided with, in sequence along a sheet conveying passage of the sheet S which is a recording material, a sheet cassette 2 which stacks the sheet S such as paper, a feeding unit 3, a conveying roller pair 4, a registration roller pair 5, a fixing unit 10, a discharging roller pair 11, and a discharging tray 12. The registration roller pair 5 is a registration roller pair. The fixing unit 10 is configured so as to be attachable to and detachable from the main assembly frame member 30.

### Operation of the image forming apparatus

Next, an operation of the image forming apparatus 1 will be described. The photosensitive drum 8, which is rotationally driven by the driving source which is not shown, is uniformly charged to a predetermined polarity and a predetermined potential by the charging member 80. After the photosensitive drum 8 is charged, an image exposure is performed onto a surface of the photosensitive drum 8 based on image information by the scanner unit 7, and an electrostatic latent image is formed when the charge is removed from an exposed area. The electrostatic latent image is developed with toner by the developing member 81 and is visualized as a toner image.

The toner image which is formed on the photosensitive drum 8 is transferred to the sheet S by the transfer roller 9. The transfer roller 9 is urged toward the photosensitive drum 8 by an urging member which is not shown. As a result, a transfer nip portion is formed between the transfer roller 9 and the photosensitive drum 8. In this way, the transfer roller 9 performs a transfer operation which transfers the toner image on the photosensitive drum 8 to a sheet S1 at the transfer nip portion.

On the other hand, the first feeding apparatus 100 is an example of a sheet supplying portion which supplies the sheet to the process cartridge 6. In the first feeding apparatus 100, the sheet S1 is fed from the sheet cassette 2 which stacks and accommodates the sheet S1 by the feeding unit 3. The sheet S1 is conveyed to the transfer nip portion via the conveying roller pair 4 and the registration roller pair 5. The toner image, which is transferred from the photosensitive drum 8 to the sheet S1 at the fixing nip portion, is fixed onto the sheet S1 under application of heat and pressure by the fixing unit 10 . The sheet S1, on which the toner image has been fixed in the fixing unit 10, is discharged onto the discharging tray 12 via the discharging roller pair 11. Incidentally, in the embodiment, the first feeding apparatus 100, which is a second unit, is described as a sheet supplying portion which supplies the sheet to the process cartridge 6, however, it is not limited to this. For example, it may be applied to a sheet conveying portion which conveys the sheet which is conveyed from the process cartridge 6.

### Bottom portion of the image forming apparatus

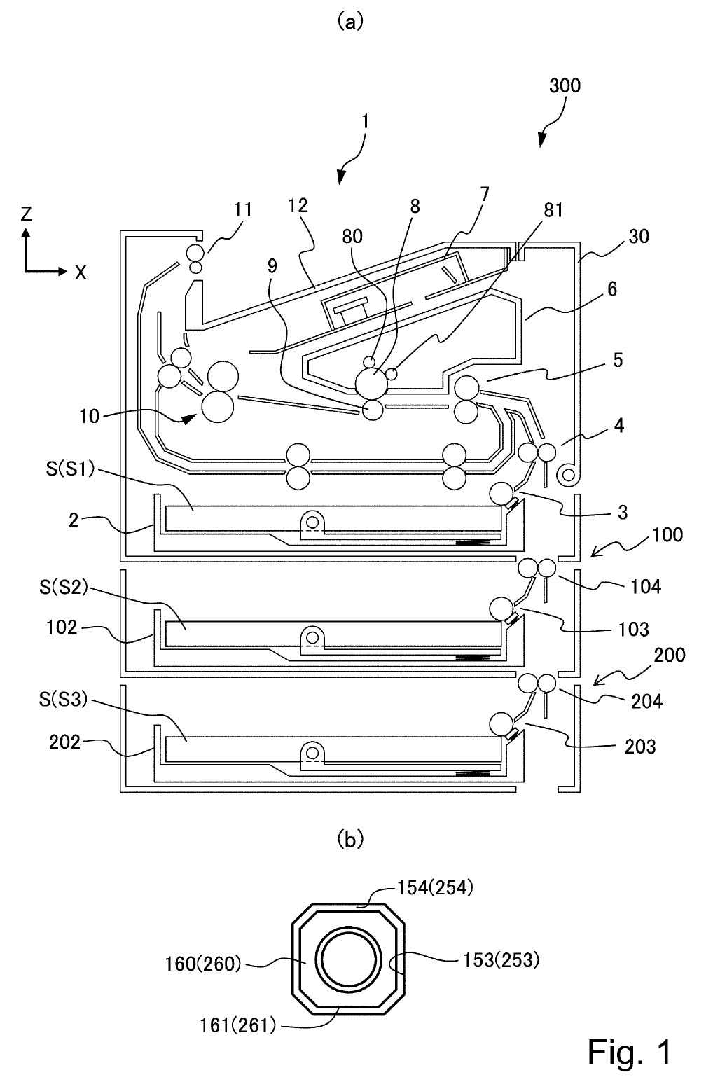

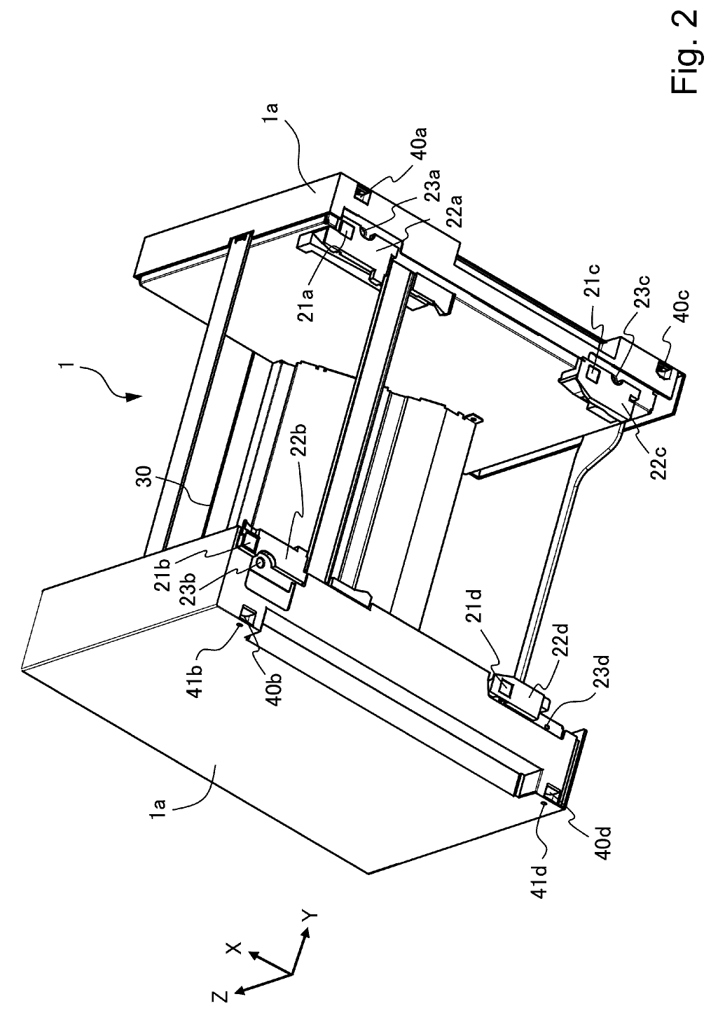

Next, a configuration of a bottom portion of the image forming apparatus 1 will be described. FIG. 2 is a perspective view of the image forming apparatus 1 as viewed from below. At four corners of a bottom surface, ground-contact portions 21a, 21b, 21c, and 21d and device mounting portions 22a, 22b, 22c, and 22d are provided. Ground-contact portions 21a, 21b, 21c, and 21d are portions which contact a grounding surface via a rubber plate, etc., when the image forming apparatus 1 is mounted on a desk, etc. The device mounting portions 22a, 22b, 22c, and 22d are planar portions which contact the first feeding apparatus 100, when the image forming apparatus 1 is mounted on an upper portion of the first feeding apparatus 100.

Here, in some cases, members whose friction coefficients are high such as rubber plates are attached to the ground-contact portions 21a, 21b, 21c, and 21d in order to prevent the image forming apparatus 1, which is mounted on the desk, etc., from sliding in a horizontal direction. Therefore, in a case that the ground-contact portions from 21a through 21d are mounted on the upper portion of the first feeding apparatus 100 when the image forming apparatus 1 is mounted on the upper portion of the first feeding apparatus 100, amounts of compression of the rubber plates which are attached to the ground-contact portions from 21a through 21d may be uneven due to differences in weight balance. As a result, the rubber plate beneath a heavier portion becomes significantly compressed and the image forming apparatus 1 is tilted with respect to the first feeding apparatus 100, so this may cause deterioration in image quality due to oblique movement while the sheet is conveyed from the first feeding apparatus 100. Therefore, when the image forming apparatus 1 is mounted on the upper portion of the first feeding apparatus 100, the device mounting portions 22a, 22b, 22c, and 22d are configured to contact directly without the rubber plate, etc., separate from the ground-contact portions 21a, 21b, 21c, and 21d. Incidentally, in a case of mounting the image forming apparatus 1 directly on the desk, it is preferable to attach rubber to the ground-contact portions 21a, 21b, 21c, and 21d in order to prioritize preventing the image forming apparatus 1 from sliding.

Further, a bottom surface portion of the image forming apparatus 1 is provided with a positioning hole 23a on a front right side, a positioning hole 23b on a front left side, a positioning hole 23c on a rear right side, and a positioning hole 23d on a rear left side. The positioning holes from 23a through 23d penetrate the bottom surface portion in the Z direction and are used for positioning by engaging with positioning pins from 124athrough 124d of the first feeding apparatus 100 which will be described below.

### First feeding apparatus and second feeding apparatus

Next, the first feeding apparatus 100 and the second feeding apparatus 200, which are externally connected to the image forming apparatus 1, will be described. As shown in part (a) of FIG. 1, the first feeding apparatus 100 is connectable to the image forming apparatus 1 from below. The first feeding apparatus 100 includes a sheet cassette 102 in which the sheet S2 is accommodated, a feeding unit 103 in which the sheet S2 is accommodated in the sheet cassette 102, and a conveying roller pair 104 which conveys the sheet S2. The sheet S2 which is accommodated in the sheet cassette 102 is fed by the feeding unit 103 and conveyed into the image forming apparatus 1 by the conveying roller pair 104, and an image is formed on the sheet S2 through the process which is described above.

The second feeding apparatus 200 is connectable to the first feeding apparatus 100 from below. The second feeding apparatus 200 includes a sheet cassette 202 which accommodates a sheet S3, a feeding unit 203 which feeds the sheet S3 which is accommodated in the sheet cassette 202, and a conveying roller pair 204 which conveys the sheet S3. The sheet S3 which is accommodated in the sheet cassette 202 is fed by the feeding unit 203 and conveyed into first feeding apparatus 100 by the conveying roller pair 204, then conveyed into the image forming apparatus 1, and the image is formed on the sheet S3 through the process which is described above.

### Joint portion between the image forming apparatus and the first feeding apparatus

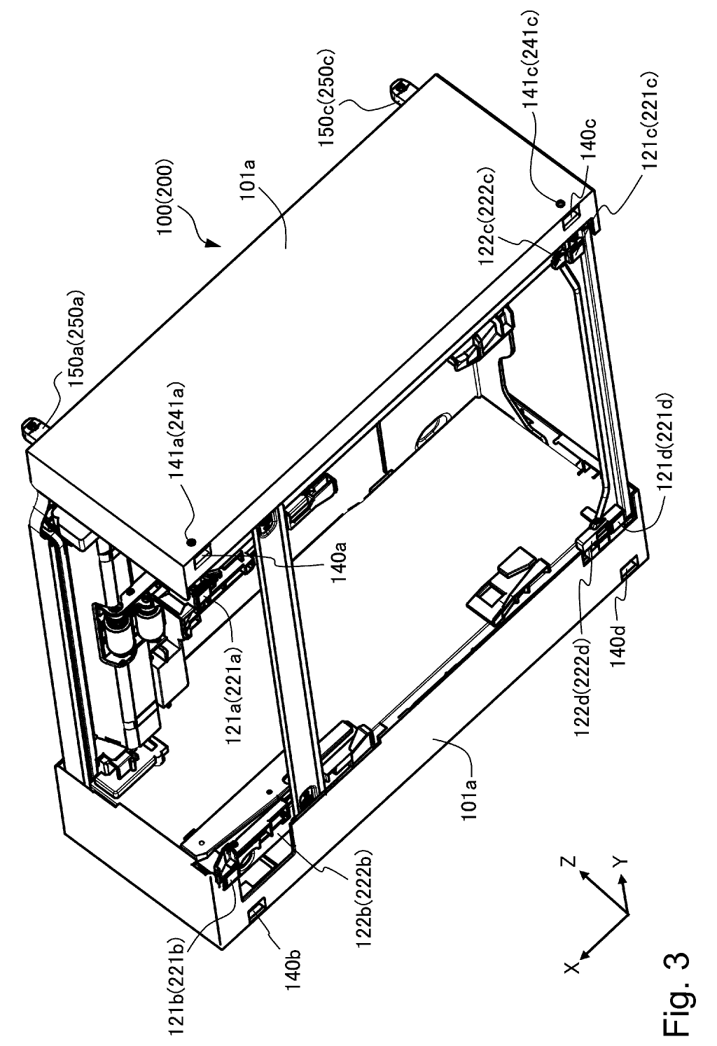

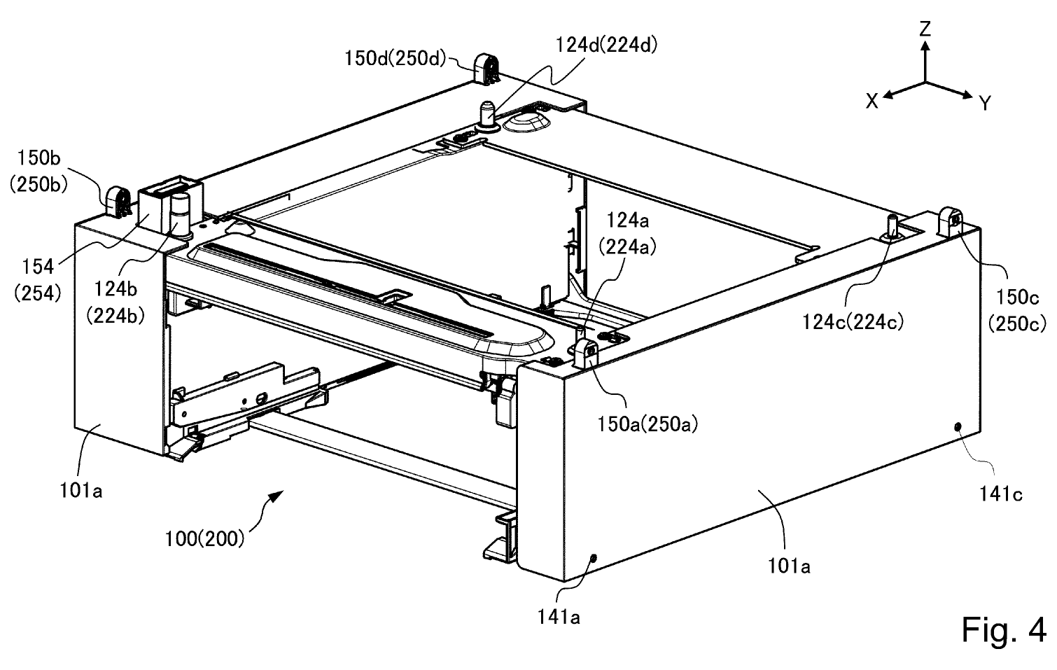

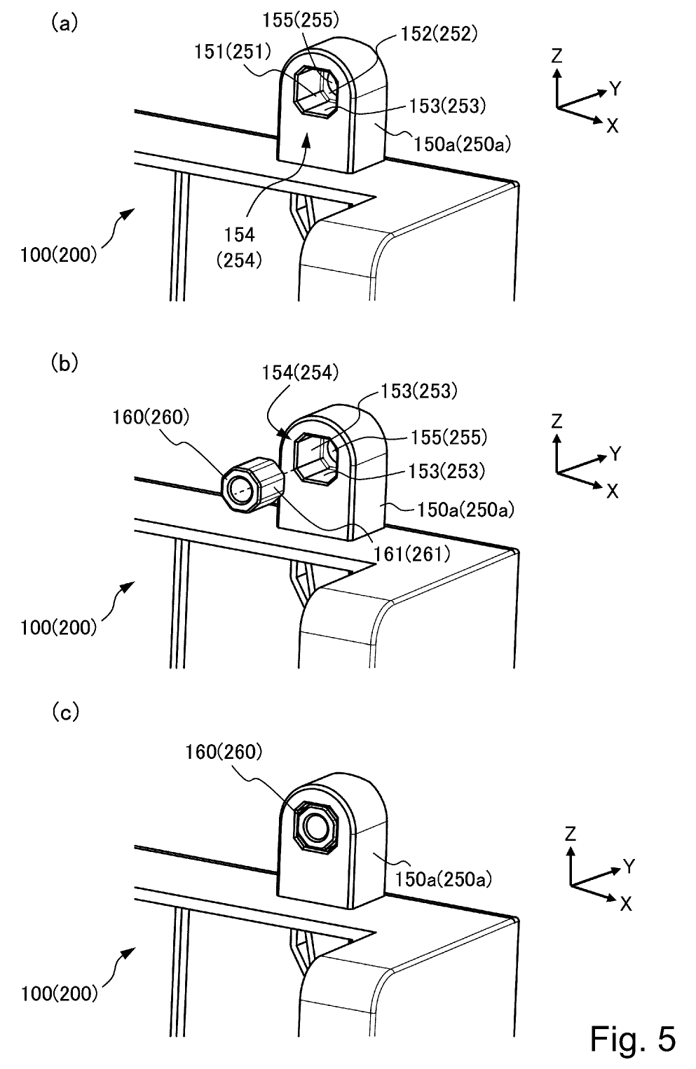

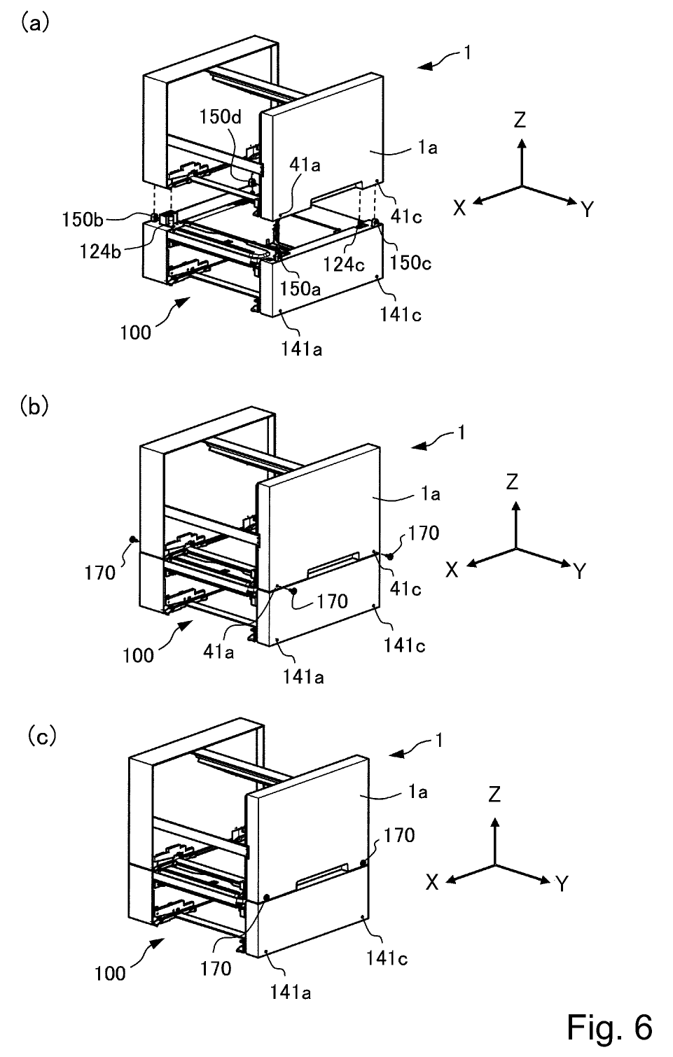

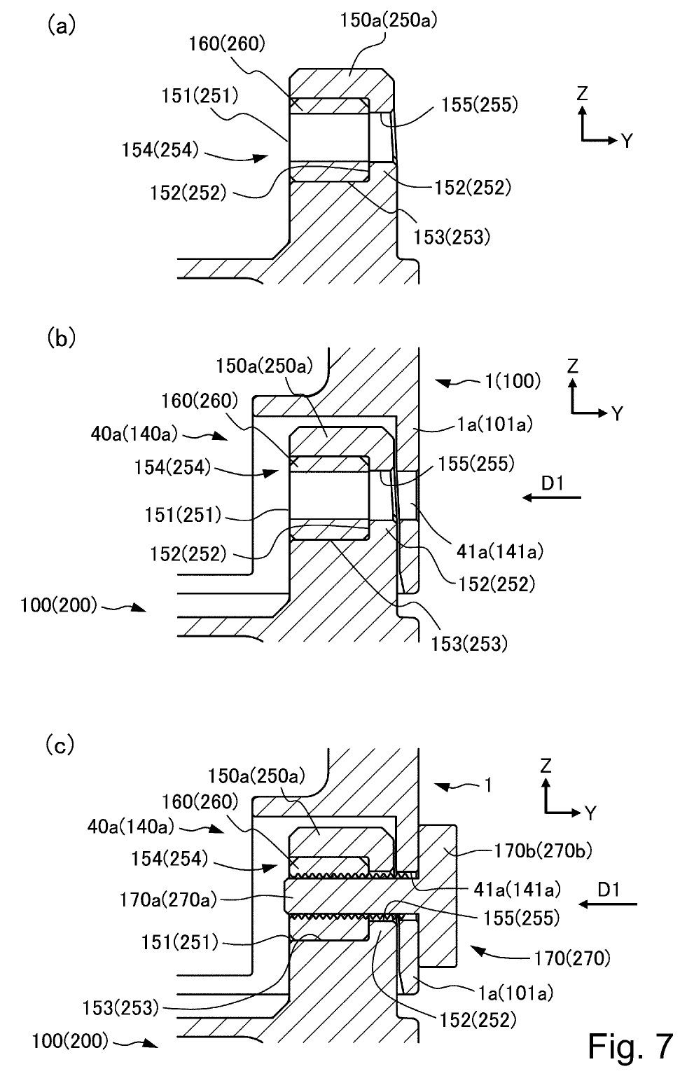

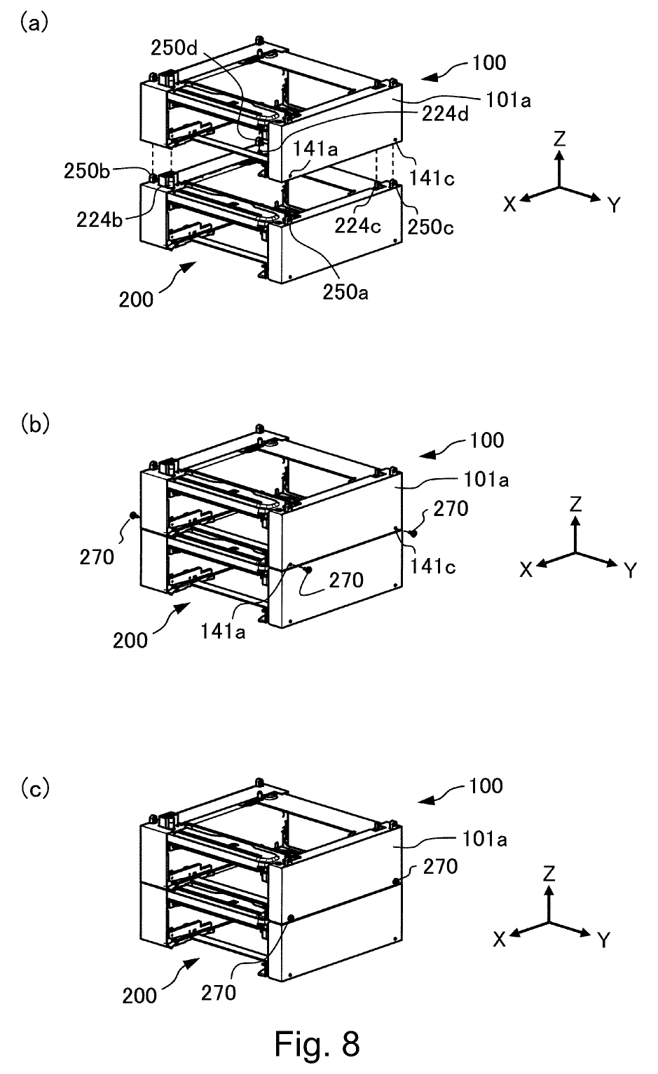

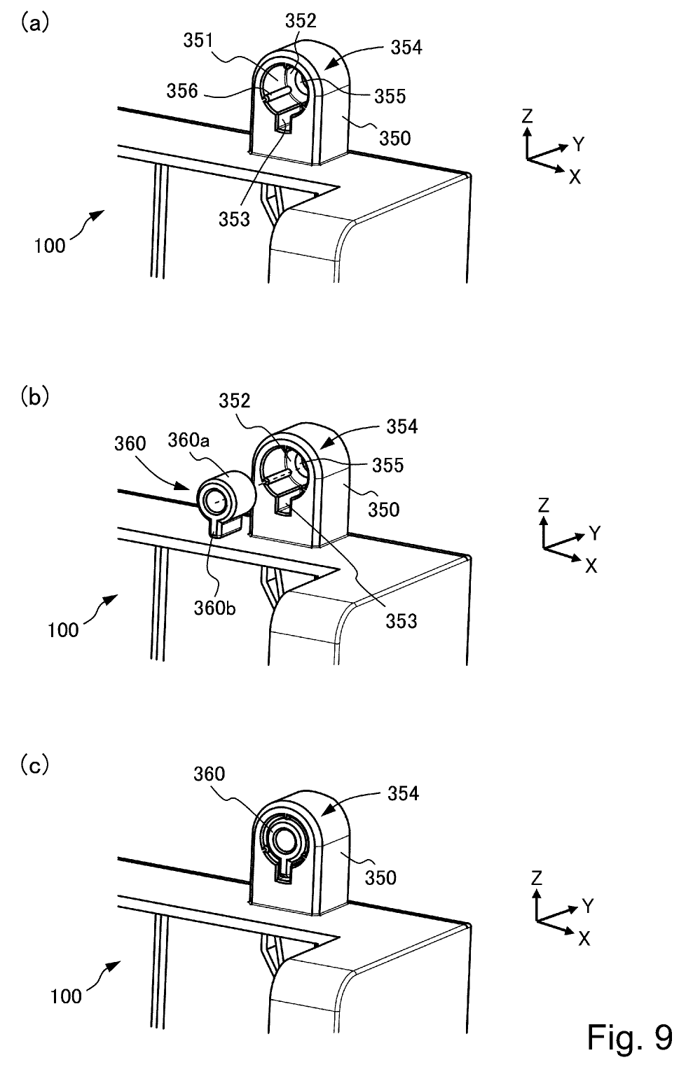

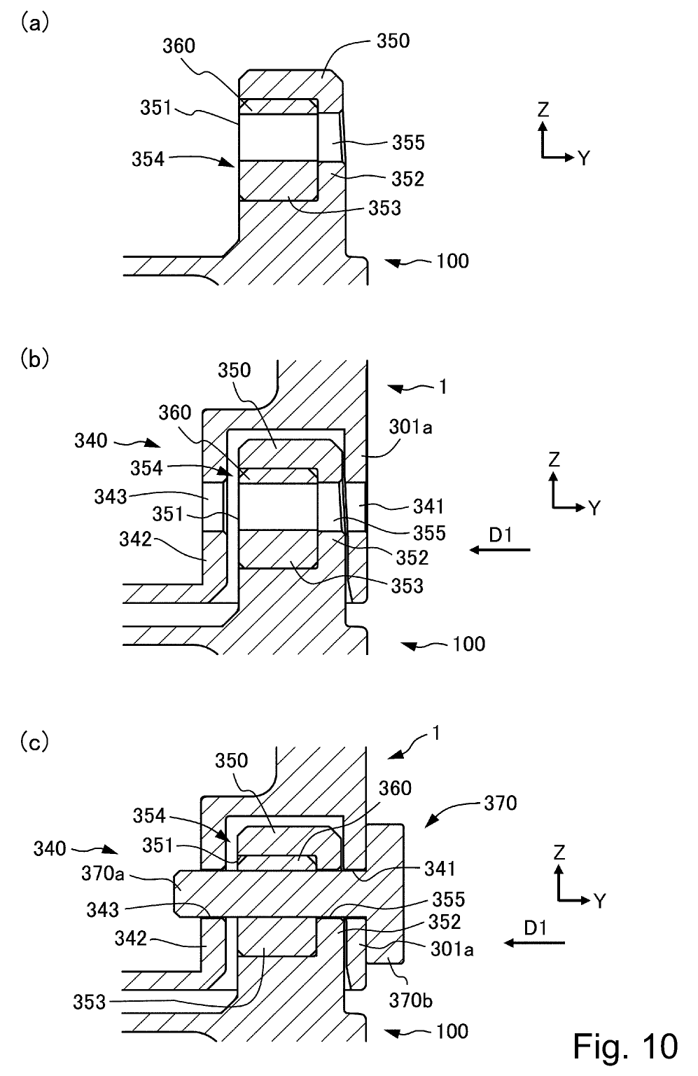

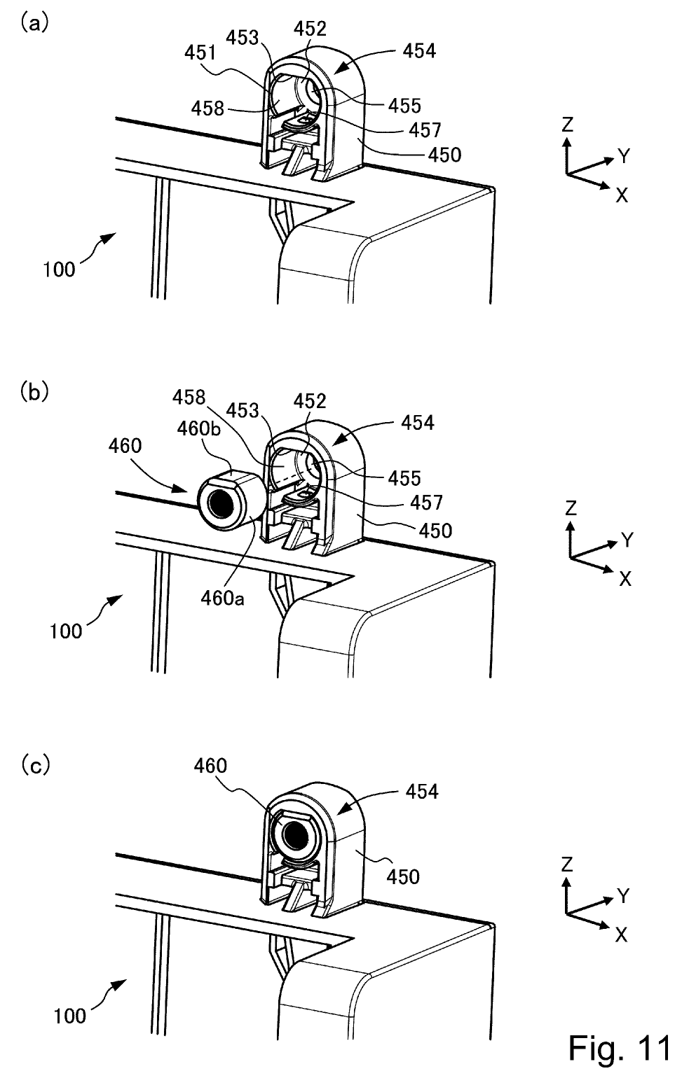

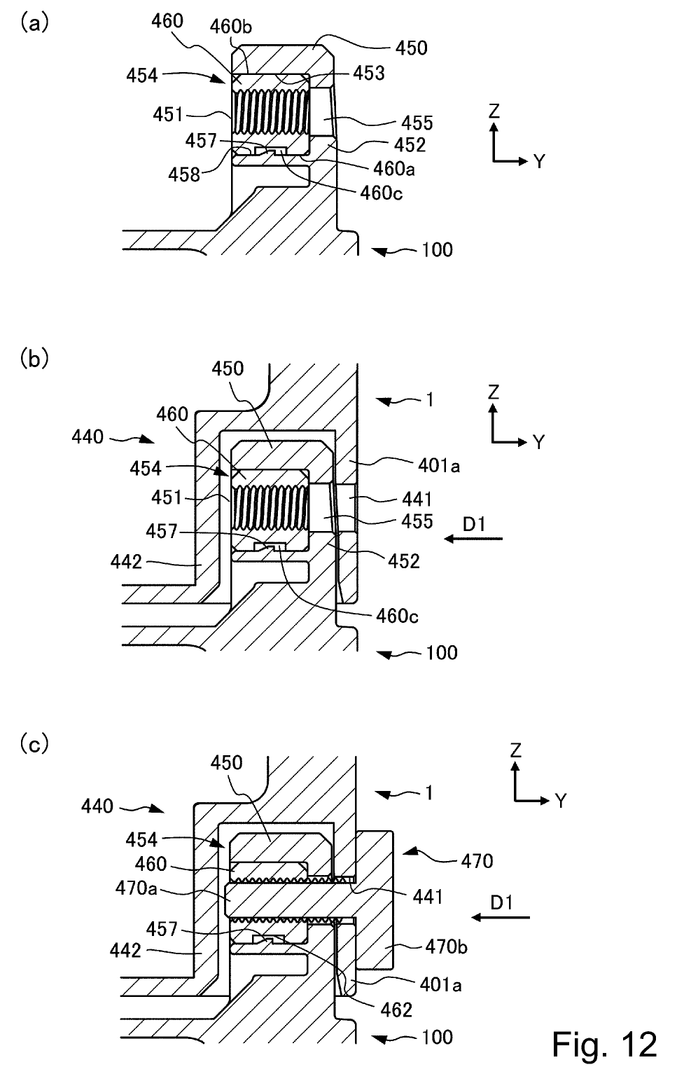

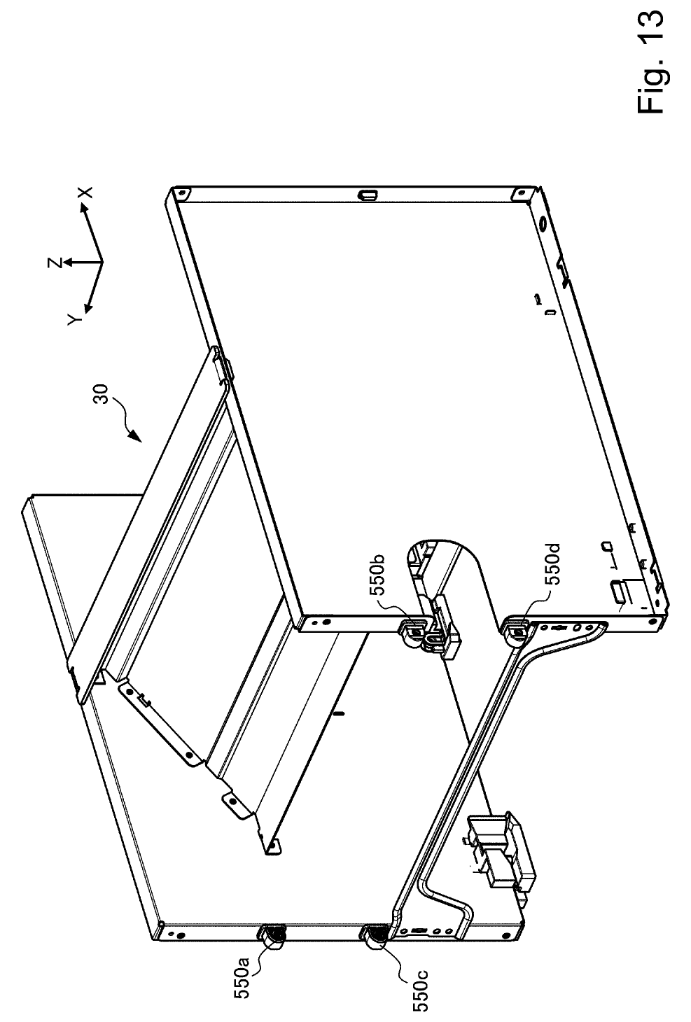

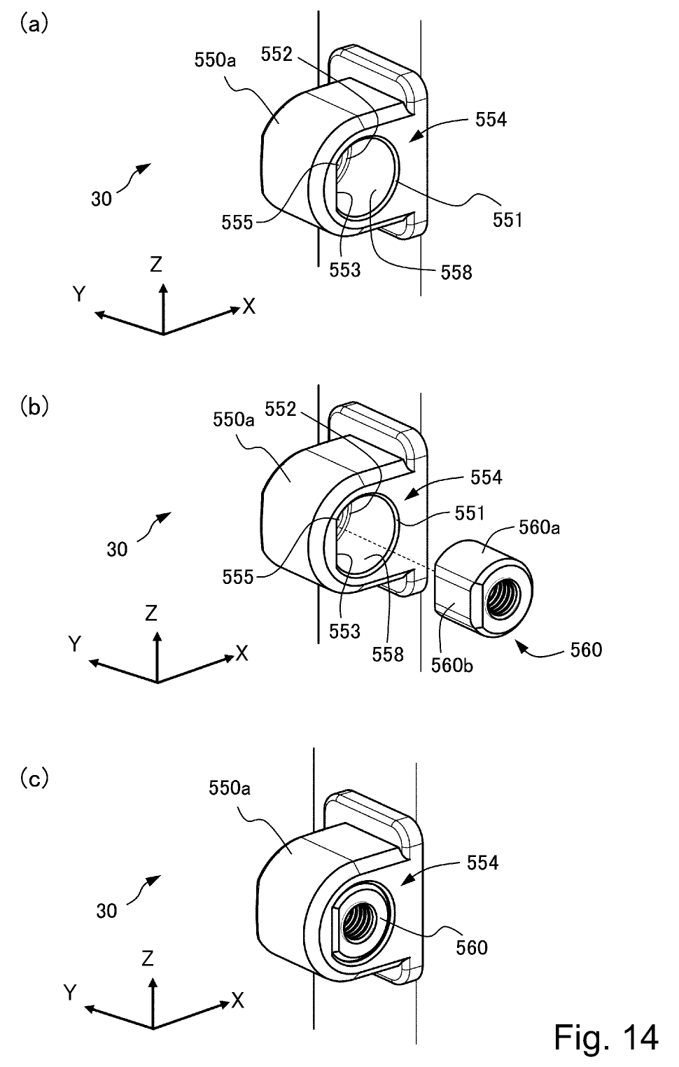

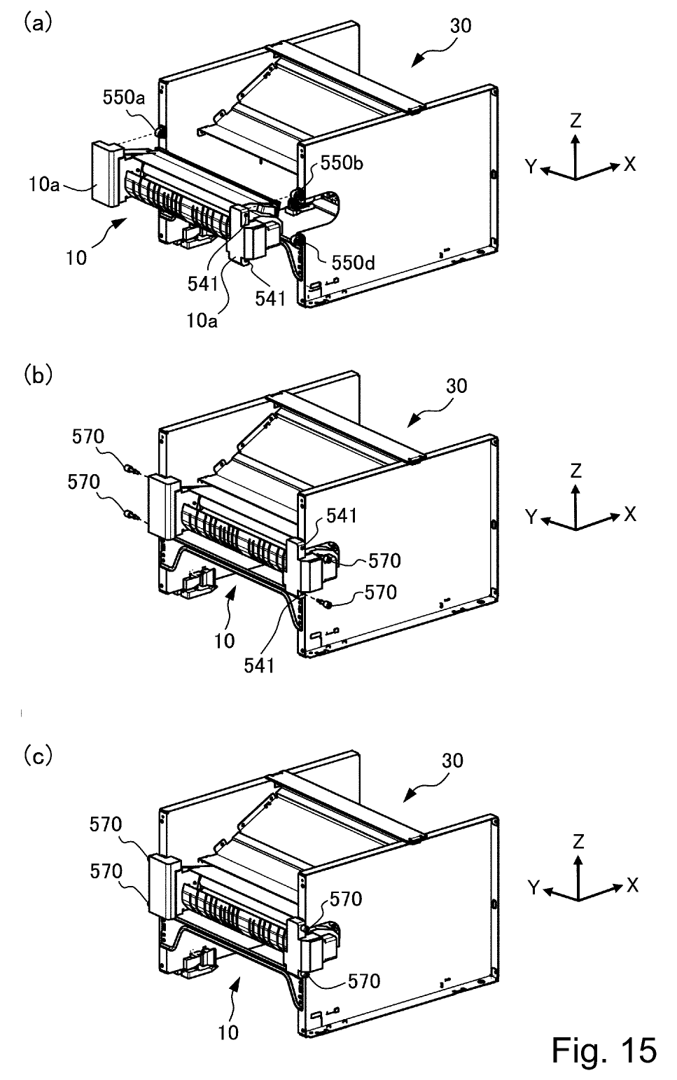

Next, a joint portion between the image forming apparatus 1 and the first feeding apparatus 100 will be described. FIG. 3 is a perspective view of the first feeding apparatus 100 as viewed from below. FIG. 4 is a perspective view of the first feeding apparatus 100 as viewed from above. As shown in FIG. 2, the image forming apparatus 1 includes, in addition to the positioning holes 23a, 23b, 23c, and 23d, a bottom surface recessed portion 40a on the front right side, a bottom surface recessed portion 40b on the front left side, a bottom surface recessed portion 40c on the rear right side, and a bottom surface recessed portion 40d on the rear left side. The bottom surface recessed portions from 40a through 40d are formed so as to be recessed upward from the bottom surface. The bottom surface recessed portions from 40a through 40d are examples of first accommodating portions, and first through holes from 41athrough 41d are respectively formed therein so as to penetrate in the Y direction.

As shown in FIG. 4, the first feeding apparatus 100 includes the positioning pin 124a on the front right side, the positioning pin 124b on the front left side, the positioning pin 124c on the rear right side, and the positioning pin 124d on the rear left side. The positioning pins from 124a through 124d are formed so as to protrude upward from a top surface. Further, the first feeding apparatus 100 includes a top surface protruding portion 150a on the right front side, a top surface protruding portion 150b on the left front side, a top surface protruding portion 150c on the right rear side, a top surface protruding portion 150d on the left rear side. The top surface protruding portions from 150a through 150d are formed so as to protrude upward from the top surface.

The top surface protruding portions from 150a through 150d of the first feeding apparatus 100 will be specifically described with reference to from part (a) through part (c) of FIG. 5. From part (a) through part (c) of FIG. 5 are perspective views of the top surface protruding portion 150a of the first feeding apparatus 100, as viewed from an inside of the first feeding apparatus 100. Part (a) of FIG. 5 is a view showing the top surface protruding portion 150a of the first feeding apparatus 100 alone, part (b) of FIG. 5 is a view showing a state before the nut 160 is accommodated in the top surface protruding portion 150a of the first feeding apparatus 100, and part (c) of FIG. 5 is a view showing a state after the nut 160 is accommodated in the top surface protruding portion 150a of the first feeding apparatus. As the top surface protruding portions from 150a through 150d are configured in the same manner, in the following, only the top surface protruding portion 150a will be described, and descriptions of the top surface protruding portions from 150b through 150d will be omitted.

As shown in from part (a) through part (c) of FIG. 5, the top surface protruding portion 150a includes an abutment portion 152 and a holding portion 154. The abutment portion 152 includes an abutment surface which is opposed to an inner side (central side) of the first feeding apparatus 100 in the Y direction, and a second through hole 155 which penetrates in the Y direction. That is, the first feeding apparatus 100 includes the abutment portion 152 in which the second through hole 155 is formed, and the holding portion 154 which is provided adjacent to the abutment portion 152.

The holding portion 154 includes an opening 151 which is open toward the inner side (central side) of the first feeding apparatus 100 in the Y direction. The nut 160 is fitted into the opening 151. That is, the holding portion 154 is an example of a second accommodating portion, and internally accommodates the nut 160. The nut 160 is mounted and held in a mounting direction which is parallel to the holding portion 154 in the Y direction (opposite direction to a penetration direction D1 which will be described below).

As shown in part (b) of FIG. 1, the nut 160 is formed with a polygonal outer shape as viewed in the penetration direction D1 which will be described below. In the embodiment, the nut 160 is formed with an octagonal prism shape, and a cylindrical through hole is formed centered on an axis of the octagonal prism. However, it is not limited to be an octagonal prism, however, any prism shape with three or more sides, such as a square prism or a hexagonal prism, may be applied. In the embodiment, when viewed in the penetration direction D1, an entire area of the nut 160 is covered within a region of the opening 151. That is, the nut 160 is accommodated inside the opening 151 and is attachable to and detachable from the holding portion 154 via the opening 151.

In the embodiment, when the nut 160 is attached to the holding portion 154, a female threaded portion is not provided in the through hole, however, subsequently, when a bolt 170 is screwed in, a thread groove is formed in the through hole, thereby providing a female threaded portion. Incidentally, a case of a configuration that the nut 160 does not include the female threaded portion at the beginning is described in the embodiment, however, it is not limited to this, and a nut which includes the female threaded portion at the beginning may also be applied. The nut 160 is positioned in an opposite direction of the penetration direction D1 by abutting against the abutment portion 152. As a result, the nut 160 is held attachable to and detachable from the holding portion 154.

The holding portion 154 includes a rotation restricting portion 153 which restricts rotation of the nut 160 about an axis extending in the Y direction. The rotation restricting portion 153 is configured of an inner peripheral surface of the holding portion 154 and includes a plurality of plane surfaces along an outer shape of the nut 160. The plurality of plane surfaces along the outer shape which is an outer peripheral surface form a rotation restricted portion 161, and the rotation of the nut 160 is restricted when the rotation restricted portion 161 is in surface contact with the rotation restricting portion 153. As a result, the nut 160 is positioned in the X direction, the Z direction, and the rotational direction, when the nut 160 is held by the holding portion 154 and the rotation restricted portion 161 contacts the rotation restricting portion 153.

Next, an operation of mounting the image forming apparatus 1 on the upper portion of the first feeding apparatus 100 will be described with reference to from part (a) through part (c) of FIG. 6. From part (a) through part (c) of FIG. 6 are all perspective views as viewed from above, when the image forming apparatus 1 is mounted on the upper portion of the first feeding apparatus 100. Part (a) of FIG. 6 shows a state before the image forming apparatus 1 is mounted on the upper portion of the first feeding apparatus 100, and part (b) of FIG. 6 shows a state after the image forming apparatus 1 is mounted on the upper portion of the first feeding apparatus 100 and before the bolts 170 are screwed. Further, part (c) of FIG. 6 shows a state while the image forming apparatus 1 and the first feeding apparatus 100 are fastened together by the bolts 170.

When mounting the image forming apparatus 1 on the upper portion of the first feeding apparatus 100, the positioning pins from 124athrough 124d of the first feeding apparatus 100 are inserted into the positioning holes from 23a through 23d of the image forming apparatus 1, and are positioned in the X direction and the Y direction. Simultaneously, the top surface protruding portions from 150a through 150d of the first feeding apparatus 100 are inserted into the bottom surface recessed portions from 40a through 40d of the image forming apparatus 1. That is, the top surface protruding portions from 150a through 150dare examples of accommodated portions, and are accommodated inside the bottom surface recessed portions from 40a through 40d, respectively (see part(b) of FIG. 7). The device mounting portions from 22a through 22d of the image forming apparatus 1 are mounted on the upper portion of the first feeding apparatus 100 and positioned in the Z direction.

### Connection between the image forming apparatus and the first feeding apparatus

From part (a) through part (c) of FIG. 7 are all sectional views in a vicinity of the top surface protruding portion 150a, while mounting the image forming apparatus 1 on the upper portion of the first feeding apparatus 100. Part (a) of FIG. 7 shows a state before the image forming apparatus 1 is mounted, part (b) of FIG. 7 shows a state while the image forming apparatus 1 is mounted on the upper portion of the first feeding apparatus 100, and part (c) of FIG. 7 shows a state while the image forming apparatus 1 and the first feeding apparatus 100 are fastened together by the bolts 170.

The image forming apparatus 1 includes an exterior panel 1a which is exposed externally in the Y direction, and the first through holes from 41a through 41d which penetrate in the Y direction are formed in the exterior panel 1a. That is, the bottom surface recessed portions from 40a through 40d include the exterior panel 1a in which the first through holes from 41a through 41d are formed. The first through holes from 41a through 41d are formed at positions overlapping the top surface protruding portions from 150athrough 150d of the first feeding apparatus 100 in the Y direction, when the image forming apparatus 1 is mounted on the first feeding apparatus 100.

The bolt 170 is an example of an engaging member which engages with the nut 160, and includes a male threaded portion 170a and a head portion 170b. The male threaded portion 170ais an example of a through shaft and penetrates the first through holes from 41athrough 41d and the second through hole 155 in the penetration direction D1 (also referred to as an insertion direction of the bolt 170) which is parallel to the Y direction, and screws in the nut 160. That is, the bolt 170 engages with the nut 160 while inserted into both the first through holes from 41a through 41d and the second through hole 155. In the embodiment, a direction which extends from the first through holes from 41a through 41d toward the second through hole 155 is defined as the penetration direction D1. In an example which is shown in part (b) of FIG. 7, for example, the penetration direction D1 is a direction from the first through hole 41a toward the second through hole 155. Further, in the embodiment, a fastening direction of the bolt 170 and the nut 160 is in the Y direction, which coincides with a mounting direction in which the nut 160 is mounted to the holding portion 154.

The head portion 170b is an example of a large diameter portion, is provided with a larger diameter than the male threaded portion 170a, and sandwiches the exterior panel 1a and the abutment portion 152 with the nut 160 in the Y direction. That is, the bolt 170 is inserted from an upstream side with respect to the penetration direction D1 into the first through holes from 41a through 41d and the second through hole 155, and sandwiches the exterior panel 1a and the abutment portion 152 between itself and the nut 160 and fastens the image forming apparatus 1 to the first feeding apparatus 100.

The male threaded portion 170a penetrates the first through holes from 41a through 41d and forms a thread groove by screwing into the through hole of the nut 160 which is fitted into the top surface protruding portions from 150a through 150d. As a result, the nut 160 and the bolt 170 are fastened together by screwing, thereby the image forming apparatus 1 and the first feeding apparatus 100 are fastened and fixed. As shown in part (c) of FIG. 7, an outer periphery of the male threaded portion 170a of the bolt 170 and the first through hole 41a are in a fitted relationship, thereby, it prevents play of the image forming apparatus 1 and the first feeding apparatus 100 in the X direction and the Z direction, which are fixed.

As shown in part (c) of FIG. 7, the opening 151 is formed at a downstream end portion of the holding portion 154 with respect to the penetration direction D1 and opens toward a downstream side of the insertion direction of the bolt 170. When connecting the image forming apparatus 1 and the first feeding apparatus 100, the nut 160 is accommodated in the holding portion 154 of the first feeding apparatus 100. At this time, since the nut 160 only needs to be mounted along the penetration direction D1, workability is improved. And the image forming apparatus 1 is mounted on the first feeding apparatus 100 from above, and the bolts 170 can be fastened in the state, so it is possible to perform connecting work easily.

Here, a force of separating the image forming apparatus 1 from the first feeding apparatus 100 in directions other than the Y direction is received by the nut 160 and the bolt 170, and is also received by a frictional force which is generated at a contact surface between the exterior panel 1a and the abutment portion 152 via the nut 160 and the bolt 170. The nut 160 is held by the rotation restricting portion 153 in the X direction and the Z direction and is held by the abutment portion 152 in the Y direction. That is, the holding portion 154 restricts the nut 160 from moving in an intersecting direction (for example, the X direction or the Z direction) which intersects the Y direction. Therefore, the nut 160 is positioned and held against forces other than those in the Y direction which separate the image forming apparatus 1 from the first feeding apparatus 100. By the configuration which is described above, while a simple configuration and a space saving design is realized, it is possible to maintain a high fixing force of the bolt 170 against external forces in the directions which separate the image forming apparatus 1 from the first feeding apparatus 100.

Here, when the bolt 170 is inserting, the nut 160 may be pushed by a leading end of the male thread portion 170a of the bolt 170 and be moved toward a downstream side with respect to an insertion direction of the bolt 170. In the case, the thread groove is formed by the male thread portion 170a, which has entered even slightly into the through hole of the nut 160 which has been moved toward a downstream side with respect to the insertion direction of the bolt 170, and the nut 160 is pulled toward the upstream side with respect to insertion direction of the bolt 170 and abuts against the abutment portion 152 after engaged with the bolt 170. With this configuration, a position of the nut 160 in the Y direction is held at a position in which the nut 160 abuts against the abutment portion 152.

When it becomes necessary to detach the nut 160 from the first feeding apparatus 100, the bolt 170 is removed and the image forming apparatus 1 is removed upward from the first feeding apparatus 100. As a result, the opening 151 is exposed, and it is possible to remove the nut 160 from the holding portion 154. That is, the opening 151 is formed so that the nut 160 is attachable to and detachable from the opening 151, in a case that the engagement between the nut 160 and the bolt 170 is released and the connection between the image forming apparatus 1 and the first feeding apparatus 100 is released.

In general, when mounting the image forming apparatus 1 on the upper portion of the first feeding apparatus 100, positional misalignment may occur between outer casings of the image forming apparatus 1 and the first feeding apparatus 100 which may lead to an unsatisfactory external appearance by mass production variations in respective mounting portions and the outer casings. In the embodiment, it is possible to suppress the positional misalignment of the first feeding apparatus 100 with respect to the exterior panel 1a, when the bolt 170 fastens the exterior panel 1a to the top surface protruding portions from 150a through 150d.

Here, in the configuration which is described in JP-A 2023-18975, since the nut must be attached to or detached from the accommodating portion through the opening which is opened in the direction which is perpendicular to the holding portion, there is an issue that replacing the nut may not be easy. That is, in the configuration which is described in JP-A 2023-18975, when removing the nut from the holding portion, it is necessary to pull the nut out of the holding portion after disengaging the bolt (engaging portion). For example, it is possible to remove the nut by using gravity in a case that the opening faces downward, however, it is necessary to remove the nut by using a thin hook shaped member or a magnet in a case that the opening faces sideward or upward, so workability is not good. Further, in a case of engaging the bolt after accommodating a new nut in the holding portion, it is necessary to hold it since the nut may fall due to gravity when the opening faces downward, for example. As described above, there is an issue of poor workability. The issue may similarly be occurred not only in a fastening configuration which uses the bolt, but also in a press fitting configuration which is comprised of a member which includes a through hole and a shaft member which is pressed and fitted into the through hole.

Furthermore, in the configuration which is described in JP-A 2023-18975, the opening does not hold the nut with respect to a direction which is perpendicular to the holding portion, since it is necessary to provide the opening which opens in the direction perpendicular to the holding portion in order to attach to and detach from the nut. Therefore, the nut may shift toward a perpendicular direction with respect to the holding portion, and a fastening force between two units in the perpendicular direction to the nut will depend on a friction force based on the fastening force. As a result, there is also an issue that it is difficult to increase a fixing force between the two units in the direction perpendicular to the nut.

On the other hand, a configuration, that the holding portion which holds the nut is formed by a resin part and the nut is bitten into the holding portion and forms an insert nut, is known (see Japanese Laid-Open Patent Application (JP-A) 2018-136034). According to the configuration, it is possible to suppress the nut from shifting in the perpendicular direction with respect to the holding portion. However, it is necessary to increase rigidity of the holding portion which is made of resin in order to maintain strong force in which the nut is bitten, therefore an increase in wall thickness and reinforcement of a structure are required and this may lead to an increase in the size of the apparatus.

As described above, according to the embodiment, the opening 151 is formed so that the nut 160 is attachable to and detachable from the opening 151, in the case that the engagement between the nut 160 and the bolt 170 is released and the connection between the image forming apparatus 1 and the first feeding apparatus 100 is released. As a result, it is possible to more easily replace the nut 160 from the holding portion 154, compared to the case that the opening 151 faces in the direction which intersects the penetration direction D1.

Further, according to the embodiment, the bolt 170 fastens the image forming apparatus 1 and the first feeding apparatus 100 by penetrating the first through holes from 41a through 41d and the second through hole 155 in the same direction as the Y direction in which the nut 160 is mounted on the holding portion 154. Further, the holding portion 154 restricts the nut 160 from moving in the intersecting direction which intersects in the Y direction. As a result, the nut 160 is positioned and held against forces other than those in the Y direction which separate the image forming apparatus 1 from the first feeding apparatus 100. Further, since the nut 160 is held so that it is attachable to and detachable from the holding portion 154, it is not necessary to increase wall thickness and reinforce the structure in holding portion 154 such as the insert nut. As a result, in the image forming system 300 which applies the bolt 170 and the nut 160 to fasten the two units, it is possible to improve the fastening force between the two units without increasing the size.

Further, since it is difficult to disengage only the nut from the insert nut, the entire resin part must be discarded in a case that the nut is damaged. When discarding the resin part into which the nut is inserted, recyclability may be reduced since the materials are mixed. On the other hand, according to the embodiment, for example, when the nut 160 is damaged, it is possible to easily remove the nut 160 from the holding portion 154, thereby maintenance and recycling are easy, so parts interchangeability and recyclability are excellent.

### Second embodiment

Next, a second embodiment of the present disclosure will be specifically described with reference to from part (a) through part (c) of FIG. 8. In the embodiment, a configuration according to the embodiment differs from the first embodiment in that the image forming apparatus 1 includes the first feeding apparatus 100 and applies the second feeding apparatus 200 as a sheet conveying apparatus. However, other configurations are the same as those of the first embodiment, and therefore, the same reference numerals will be used and detailed descriptions will be omitted. Here, since the first feeding apparatus 100 and the second feeding apparatus 200 have similar configurations, the figures which shows the first feeding apparatus 100 in part (a) of FIG. 1 through part (c) of FIG. 7 (c) are applied to the second feeding apparatus 200, and reference numerals are indicated in brackets.

In the embodiment, the first feeding apparatus 100 is an example of a first sheet supplying portion which conveys the sheet between itself and the process cartridge 6, and is connected to the process cartridge 6 which forms the image on the sheet S, and supplies the sheet S toward the process cartridge 6. The second feeding apparatus 200 is an example of the second sheet supplying portion which conveys the sheet between itself and the first feeding apparatus 100 and supplies the sheet S to the process cartridge 6 via the first feeding apparatus 100.

Next, an operation of mounting the first feeding apparatus 100 on the upper portion of the second feeding apparatus 200 will be described with reference to from part (a) through part (c) of FIG. 8. From part (a) through part (c) of FIG. 8 are all perspective views as viewed from above, when the first feeding apparatus 100 is mounted on the upper portion of the second feeding apparatus 200. Part (a) of FIG. 8 shows a state before the first feeding apparatus 100 is mounted on the upper portion of the second feeding apparatus 200, and part (b) of FIG. 8 shows a state after the first feeding apparatus 100 is mounted on the upper portion of the second feeding apparatus 200 and before the bolts are screwed. Furthermore, part (c) of FIG. 8 shows a state while the first feeding apparatus 100 and the second feeding apparatus 200 are fastened together by the bolts. The bolt 270 is an example of an engaging member, and includes a male threaded portion 270a and a head portion 270b.

When mounting the first feeding apparatus 100 on the upper portion of the second feeding apparatus 200, positioning pins from 224a through 224d of the second feeding apparatus 200 are inserted into positioning holes (not shown) of the first feeding apparatus 100, and are positioned in the X direction and the Y direction. Simultaneously, top surface protruding portions from 250a through 250d of the second feeding apparatus 200 are inserted into bottom surface recessed portions from 140a through 140d(see FIG. 3) of the first feeding apparatus 100. The bottom surface recessed portions from 140a through 140d are examples of the first accommodating portions, and first through holes from 141a through 141dare respectively formed therein so as to penetrate in the Y direction. Device mounting portions from 122a through 122d (see FIG. 3) of the first feeding apparatus 100 are mounted on the upper portion of the second feeding apparatus 200 and positioned in the Z direction.

### Connection between the first feeding apparatus and the second feeding apparatus

From part (a) through part (c) of FIG. 7 are the sectional views in the vicinity of the top surface protruding portion 150a, while mounting the image forming apparatus 1 on the upper portion of the first feeding apparatus 100, however, in here, from part (a) through part (c) of FIG. 7 are used as sectional views while mounting the first feeding apparatus 100 on the upper portion of the second feeding apparatus 200.

The first feeding apparatus 100 includes an exterior panel 101a which is exposed externally in the Y direction, and the first through holes from 141a through 141d which penetrate in the Y direction are formed in the exterior panel 101a. That is, the bottom surface recessed portions from 140a through 140d include the exterior panel 1a in which the first through holes from 141a through 141d are formed. The first through holes from 141a through 141d are formed at positions overlapping the top surface protruding portions from 250a through 250d of the second feeding apparatus 200 in the Y direction, when the first feeding apparatus 100 is mounted on the second feeding apparatus 200.

The bolt 270 is inserted from the upstream side with respect to the penetration direction D1 into the first through holes from 141a through 141d and the second through hole 255. The bolt 270 sandwiches the exterior panel 101aof the first feeding apparatus 100 and the abutment portion 252 of the second feeding apparatus 200 between itself and the nut 260 and fastens the first feeding apparatus 100 to the second feeding apparatus 200.

The holding portion 254 includes a rotation restricting portion 253 which restricts rotation of the nut 260 about the axis extending in the Y direction. When it becomes necessary to detach the nut 260 from the second feeding apparatus 200, the bolt 270 is removed and the first feeding apparatus 100 is removed upward from the second feeding apparatus 200. As a result, an opening 251 is exposed, and it is possible to remove the nut 260 from the holding portion 254. That is, the opening 251 is formed so that the nut 260 is attachable to and detachable from the opening 251, in a case that the engagement between the nut 260 and the bolt 270 is released and the connection between the first feeding apparatus 100 and the second feeding apparatus 200 is released.

As described above, according to the embodiment, the opening 251 is formed so that the nut 260 is attachable to and detachable from the opening 251, in the case that the engagement between the nut 260 and the bolt 270 is released and the connection between the first feeding apparatus 100 and the second feeding apparatus 200 is released. As a result, it is possible to more easily replace the nut 260 from the holding portion 254, compared to the case that the opening 251 faces in the direction which intersects the penetration direction D1.

Further, according to the embodiment, the bolt 270 fastens the first feeding apparatus 100 and the second feeding apparatus 200 by penetrating the first through holes from 141a through 141dand the second through hole 255 in the same direction as the Y direction in which the nut 260 is mounted on the holding portion 254. Further, the holding portion 254 restricts the nut 260 from moving in the intersecting direction which intersects in the Y direction. As a result, the nut 260 is positioned and held against forces other than those in the Y direction which separate the first feeding apparatus 100 from the second feeding apparatus 200. Further, since the nut 260 is held so that it is attachable to and detachable from the holding portion 254, it is not necessary to increase wall thickness and reinforce the structure in holding portion 254 such as the insert nut. As a result, in the image forming system 300 which applies the bolt 270 and the nut 260 to fasten the two units, it is possible to improve the fastening force between the two units without increasing the size.

### Third embodiment

Next, a third embodiment of the present disclosure will be specifically described with reference to from part (a) through part (c) of FIG. 9. In the embodiment, a configuration according to the embodiment differs from the first embodiment in that the engagement between the engaging portion and the nut is performed by press fitting. However, other configurations are the same as those of the first embodiment, and therefore, the same reference numerals will be used and detailed descriptions will be omitted. In the embodiment, similar to the first embodiment, the first feeding apparatus 100 includes top surface protruding portions at four sides of the right front side, the left front side , the right rear side, and the left rear side on the top surface (see FIG. 4). In here, as each of the top surface protruding portions is configured in the same manner, in the following, only the top surface protruding portion 350 at the right front side will be described, and descriptions of other top surface protruding portions will be omitted.

The image forming apparatus 1 includes bottom surface recessed portions 340 at the four sides on the bottom surface, similar to the first embodiment. The bottom surface recessed portions 340 are examples of the first accommodating portions, and first through holes 341 are respectively formed therein so as to penetrate in the Y direction. The image forming apparatus 1 includes an exterior panel 301a which is exposed externally in the Y direction, and the first through holes 341 which penetrate in the Y direction are formed in the exterior panel 301a. The first through holes 341 are formed at positions overlapping the four top surface protruding portions 350 of the first feeding apparatus 100 in the Y direction, when the first feeding apparatus 100 is mounted on the image forming apparatus 1 (see FIG. 2).

The top surface protruding portions 350 of the first feeding apparatus 100 will be described with reference to from part (a) through part (c) of FIG. 9. From part (a) through part (c) of FIG. 9 are perspective views of the top surface protruding portion 350 of the first feeding apparatus 100, as viewed from the inside of the first feeding apparatus 100. Part (a) of FIG. 9 is a view showing the top surface protruding portion 350 of the first feeding apparatus 100 alone, part (b) of FIG. 9 is a view showing a state before a cylindrical member 360 is fitted into the top surface protruding portion 350, and part (c) of FIG. 9 is a view showing a state after a cylindrical member 360 is fitted into the top surface protruding portion 350.

As shown in from part (a) through part (c) of FIG. 9, the top surface protruding portion 350 includes an abutment portion 352 and a holding portion 354. The abutment portion 352 includes an abutment surface which is opposed to the inner side (central side) of the first feeding apparatus 100 in the Y direction, and a second through hole 355 which penetrates in the Y direction. The holding portion 354 includes an opening 351 which is open toward the inner side (central side) of the first feeding apparatus 100 in the Y direction. The cylindrical member 360 is fitted into the opening 351. That is, the holding portion 354 is an example of the second accommodating portion, and internally accommodates the cylindrical member 360.

The cylindrical member 360 is mounted and held in the holding portion 354 from the opposite direction to the penetration direction D1. The cylindrical member 360 includes a cylindrical portion 360a including an outer peripheral surface about the axis as viewed in the Y direction and a projecting portion 360b projecting from the outer peripheral surface of the cylindrical portion 360a in a direction away from the axis. The cylindrical portion 360a is an example of an arc shaped portion on the outer peripheral surface of the cylindrical member 360, and the projecting portion 360b is an example of a second rotation restricted portion which projects outward in a radial direction and abuts the rotation restricting portion 353 which will be described below. The cylindrical member 360 is positioned in the opposite direction of the penetration direction D1 by abutting against the abutment portion 352. The cylindrical member 360 is held attachable to and detachable from the holding portion 354.

The holding portion 354 includes a rotation restricting portion 353 which restricts rotation of the cylindrical member 360 about the axis extending in the Y direction. The rotation restricting portion 353 is configured of a groove portion which is formed along the projecting portion 360b. By mounting the cylindrical member 360 onto the holding portion 354, the projecting portion 360b of the cylindrical member 360 engages with the groove shaped rotation restricting portion 353, and the rotation of the cylindrical member 360 is restricted. Further, the holding portion 354 includes a plurality of rib portions 356 which holds the outer peripheral surface of the cylindrical portion 360a. In the embodiment, the plurality of rib portions 356 are provided at three locations which are spaced approximately 120 degrees apart in a peripheral direction about the axis. The outer peripheral surface of the cylindrical portion 360a is fixed in the X direction and the Z direction by contacting three of the rib portions 356. As a result, the cylindrical member 360 is positioned in the X direction, the Z direction, and the rotational direction, when the cylindrical member 360 is held by the holding portion 354. In the embodiment, the outer peripheral surface of the cylindrical member 360 is press fitted into the holding portion 354 by being press fitted between three of the rib portions 356, and detachment in the Y direction is prevented. However, the cylindrical member 360 can be removed from the holding portion 354 by applying a force in the penetration direction D1 which exceeds a fixing force which is provided by the press fit.

In the embodiment, a pin member 370 which is an example of an engaging portion, and the cylindrical member 360 which is an example of a nut, are applied in order to connect the image forming apparatus 1 and the first feeding apparatus 100. The pin member 370 includes a pin portion 3370a and a head portion 370b. The pin portion 370a is an example of a through shaft and penetrates the first through hole 341 and the second through hole 355. The head portion 370b is an example of a large diameter portion, is provided with a larger diameter than the pin portion 370a, and sandwiches the exterior panel 301a of the image forming apparatus 1 and the abutment portion 352 of the first feeding apparatus 100 with the pin portion 370a in the Y direction.

### Connection between the image forming apparatus and the first feeding apparatus

From part (a) through part (c) of FIG. 10 are all sectional views in a vicinity of the top surface protruding portion 350, while mounting the image forming apparatus 1 on the upper portion of the first feeding apparatus 100. Part (a) of FIG. 10 shows a state before the image forming apparatus 1 is mounted, part (b) of FIG. 10 shows a state while the image forming apparatus 1 is mounted on the upper portion of the first feeding apparatus 100, and part (c) of FIG. 10 shows a state while the image forming apparatus 1 and the first feeding apparatus 100 are connected by the pin portion 370.

As shown in part (b) of FIG. 10, a first movement restricting portion 342 is formed on a lower end portion of the exterior panel 301a of the image forming apparatus 1, downstream (inside of the apparatus) of the top surface protruding portion 350 in the penetration direction D1. When the image forming apparatus 1 is mounted on the upper portion of the first feeding apparatus 100, the first movement restricting portion 342 of the image forming apparatus 1 is disposed on a downstream side of the opening 351 with respect to the penetration direction D1 of the pin member 370. That is, the image forming apparatus 1 includes the first movement restricting portion 342 which is disposed on a downstream side of the holding portion 354 with respect to the penetration direction D1 and also restricts the cylindrical member 360 which is held by the holding portion 354 from moving toward a downstream side with respect to the penetration direction D1.

The first movement restricting portion 342 includes a through hole 343 which penetrates in the Y direction coaxially with the pin member 370. The through hole 343 is an example of a hole portion, into which a pin portion 370a projecting downstream in the penetration direction D1 from the cylindrical member 360 is inserted. In the embodiment, it is described in the case of the through hole 343 which is penetrating in the Y direction, however, it is not limited this and it may also be a recessed hole portion which is not penetrating.

As shown in part (c) of FIG. 10, the pin portion 370a of the pin member 370 penetrates the first through hole 341 and the second through hole 355 and is inserted into the cylindrical member 360 which is held by the top surface protruding portion 350, thereby fixing the Z direction relationship between the image forming apparatus 1 and the first feeding apparatus 100. That is, the pin member 370 connects the image forming apparatus 1 and the first feeding apparatus 100 by sandwiching the exterior panel 301a of the image forming apparatus 1 and the abutment portion 352 of the first feeding apparatus 100 between itself and the cylindrical member 360 when it is press fit into the cylindrical member 360.

The pin portion 370a of the pin member 370 and the first through hole 341 are in a fitted relationship, thereby, it prevents play of the image forming apparatus 1 and the first feeding apparatus 100 which are connected. Further, a leading end of the pin member 370 is inserted into the through hole 343 in which the first movement restricting portion 342 includes, thereby ensuring a fitting length of the pin member 370 and stabilizing an attitude of the pin member 370. By the configuration which is described above, while a simple configuration and a space saving design is realized, it is possible to maintain a high fixing force of the pin member 370 against external forces in the directions which separate the image forming apparatus 1 from the first feeding apparatus 100.

Here, when inserting the pin member 370, a force may act to push the cylindrical member 360 toward a downstream side of the insertion direction of the pin member 370. At this time, it is expected that the pushing force which applied by an operator is greater than a holding force of the cylindrical member 360 due to press fitting into the rib portions 356. On the other hand, when the pin member 370 is press fitted, as shown in part (c) of FIG. 10, since the image forming apparatus 1 is mounted, the cylindrical member 360 abuts against the first movement restricting portion 342 and is restricted from moving in the penetration direction D1. As a result , it is possible to prevents the cylindrical member 360 from unintentionally falling out of the holding portion 354.

When it becomes necessary to detach the cylindrical member 360 from the first feeding apparatus 100, the pin member 370 is removed and the image forming apparatus 1 is removed upwardly from the first feeding apparatus 100. As a result, it is possible to detach the cylindrical member 360 by applying a force which pushes the cylindrical member 360 to a downstream side of the insertion direction of the pin member 370, since the opening 351 is exposed.

As described above, according to the embodiment, the opening 351 is formed so that the cylindrical member 360 is attachable to and detachable from the opening 351 in the case in which the engagement of the cylindrical member 360 and the pin member 370 is released and connection of the image forming apparatus 1 and the first feeding apparatus 100 is released. As a result, it is possible to more easily replace the cylindrical member 360 from the holding portion 354, compared to the case that the opening 351 faces in the direction which intersects the penetration direction D1.

Further, according to the embodiment, the pin member 370 connects the image forming apparatus and the first feeding apparatus 100 by penetrating the first through hole 341 and the second through hole 355 in the same direction as the Y direction in which the cylindrical member 360 is mounted on the holding portion 354. Further, the holding portion 354 restricts the cylindrical member 360 from moving in the intersecting direction which intersects in the Y direction. As a result, the cylindrical member 360 is positioned and held against forces other than those in the Y direction which separate the image forming apparatus 1 from the first feeding apparatus 100. Further, since the cylindrical member 360 is held so that it is attachable to and detachable from the holding portion 354, it is not necessary to increase wall thickness and reinforce the structure in holding portion 354 such as the insert nut. As a result, in the image forming system 300 which applies the pin member 370 and the cylindrical member 360 to fasten the two units, it is possible to improve the fastening force between the two units without increasing the size.

Further, according to the embodiment, the cylindrical member 360 abuts against the first movement restricting portion 342 and is restricted from moving in the penetration direction D1. As a result, when the pin member 370 is press fitted into the cylindrical member 360, it is possible to prevents the cylindrical member 360 from unintentionally falling out of the holding portion 354.

Incidentally, in the embodiment which is described above, similar to the first embodiment, a case that the first feeding apparatus 100 is an example of a sheet supplying apparatus is described, however, it is not limited to this. For example, similar to the second embodiment, the first feeding apparatus 100 may be an example of the image forming apparatus 1, and the second feeding apparatus 200 may be an example of the sheet conveying apparatus. In the case as well, it may be applied as a configuration of connecting the first feeding apparatus 100 and the second feeding apparatus 200.

### Fourth embodiment

Next, a fourth embodiment of the present disclosure will be specifically described with reference to from part (a) through part (c) of FIG. 11. In the embodiment, a configuration differs from the first embodiment in that a retaining configuration of a nut 460 is provided with the holding portion 454. However, other configurations are the same as those of the first embodiment, and therefore, the same reference numerals will be used and detailed descriptions will be omitted. In the embodiment, similar to the first embodiment, the first feeding apparatus 100 includes top surface protruding portions at the four sides of the right front side, the left front side , the right rear side, and the left rear side on the top surface (see FIG. 4). In here, as each of the top surface protruding portions is configured in the same manner, in the following, only the top surface protruding portion 450 at the right front side will be described, and descriptions of other top surface protruding portions will be omitted.

The image forming apparatus 1 includes bottom surface recessed portions 440 at the four sides on the bottom surface, similar to the first embodiment. The bottom surface recessed portions 440 are examples of the first accommodating portions, and first through holes 441 are respectively formed therein so as to penetrate in the Y direction. The image forming apparatus 1 includes an exterior panel 401a which is exposed externally in the Y direction, and the first through holes 441 which penetrate in the Y direction are formed in the exterior panel 401a. The first through holes 441 are formed at positions overlapping the four top surface protruding portions 450 of the first feeding apparatus 100 in the Y direction, when the first feeding apparatus 100 is mounted on the image forming apparatus 1 (see FIG. 2).

The top surface protruding portions 450 of the first feeding apparatus 100 will be described with reference to from part (a) through part (c) of FIG. 11. From part (a) through part (c) of FIG. 11 are perspective views of the top surface protruding portion 450 of the first feeding apparatus 100, as viewed from the inside of the first feeding apparatus 100. Part (a) of FIG. 11 is a view showing the top surface protruding portion 450 of the first feeding apparatus 100 alone, part (b) of FIG. 11 is a view showing a state before the nut 460 is fitted into the top surface protruding portion 450, and part (c) of FIG. 11 is a view showing a state after the nut 460 is fitted into the top surface protruding portion 450.

As shown in from part (a) through part (c) of FIG. 11, the top surface protruding portion 450 includes an abutment portion 452 and the holding portion 454. The abutment portion 452 includes an abutment surface which is opposed to the inner side (central side) of the first feeding apparatus 100 in the Y direction, and a second through hole 455 which penetrates in the Y direction. The holding portion 454 includes an opening 451 which is open toward the inner side (central side) of the first feeding apparatus 100 in the Y direction. The nut 460 is fitted into the opening 451. That is, the holding portion 454 is an example of the second accommodating portion, and internally accommodates the nut 460.

The nut 460 is mounted and held in a direction which is an opposite direction to the penetration direction D1 with respect to the holding portion 454. An outer peripheral surface of the nut 460 includes an arc surface 460a about the axis as viewed in the Y direction and a chamfered portion 460b extending in a straight line. That is, the arc surface 460a forms a circular peripheral surface, and the chamfered portion 460b forms a flat surface. The nut 460 includes a through hole with a cross-sectional circular shape about the axis, and a female threaded portion is formed on its inner peripheral surface. The nut 460 is positioned in the opposite direction of the penetration direction D1 by abutting against the abutment portion 452. The nut 460 is held attachable to and detachable from the holding portion 454.

The holding portion 454 includes an circular peripheral surface portion 458 which is an inner peripheral surface about the axis extending in the Y direction and a rotation restricting portion 453 which restricts rotation of the nut 460 about the axis extending in the Y direction. The rotation restricting portion 453 is configured of a plane which is formed along the chamfered portion 460b of the nut 460. By mounting the nut 460 onto the holding portion 454, the chamfered portion 460b of the nut 460 is in surface contact with the rotation restricting portion 453 and the rotation of the nut 460 is restricted. The arc surface 460a of the nut 460 is fixed in the X direction and the Z direction by being in surface contact with the circular peripheral surface portion 458 of the holding portion 454. As a result, the nut 460 is positioned in the X direction, the Z direction, and the rotational direction, when the nut 460 is held by the holding portion 454. In the embodiment, the nut 460 and the holding portion 454 are held together in a clearance fit relationship.

### Connection between the image forming apparatus and the first feeding apparatus

From part (a) through part (c) of FIG. 12 are all sectional views in a vicinity of the top surface protruding portion 450, while mounting the image forming apparatus 1 on the upper portion of the first feeding apparatus 100. Part (a) of FIG. 12 shows a state before the image forming apparatus 1 is mounted, part (b) of FIG. 12 shows a state while the image forming apparatus 1 is mounted on the upper portion of the first feeding apparatus 100, and part (c) of FIG. 12 shows a state while the image forming apparatus 1 and the first feeding apparatus 100 are fastened together by bolts 470.

As shown in part (a) of FIG. 12, a second movement restricting portion 457 is formed on the circular peripheral surface portion 458 of the holding portion 454. The second movement restricting portion 457 is configured of a protrusion which projects from a lower portion of the circular peripheral surface portion 458 toward an inner peripheral side (that is, upward). An upper surface of the second movement restricting portion 457 is an inclined surface which becomes lower toward the opening 451 side. Further, the nut 460 includes an engagement groove 460c in a lower portion of the arc surface 460a. The engagement groove 460c is an example of an engaged portion, and engages with the second movement restricting portion 457 in a state of being mounted on the holding portion 454. Incidentally, in the embodiment, the second movement restricting portion 457 is described as being provided with the holding portion 454, however, it is not limited to this, and it may also be provided outside the opening 451, for example.

When mounting the nut 460 on the holding portion 454, the arc surface 460a of the nut 460 is guided by the inclined surface of the second movement restricting portion 457, and the second movement restricting portion 457 is deflected downward and retracted. By inserting the nut 460 until it abuts against the abutment portion 452, the second movement restricting portion 457 is returned and engaged with the engagement groove 460c. As a result, the second movement restricting portion 457 is provided downstream of the abutment portion 152 in the penetration direction D1, and restricts the nut 460 which is held by the holding portion 454 from moving downstream in the penetration direction D1. By the configuration, it is possible to prevent the nut 460 from falling unintentionally, in a case that the first feeding apparatus 100 is tilted, etc., while the image forming apparatus 1 is not mounted on the first feeding apparatus 100. Further, when mounting the nut 460 on the holding portion 454, press-fitting is not required, so it is possible to assemble with a small force.

As shown in part (b) of FIG. 12, a first movement restricting portion 442 is formed at a lower end portion of the exterior panel 401a of the image forming apparatus 1, downstream (inside of the apparatus) of the top surface protruding portion 450 in the penetration direction D1. When the image forming apparatus 1 is mounted on the upper portion of the first feeding apparatus 100, the first movement restricting portion 442 of the image forming apparatus 1 is disposed on a downstream side of the opening 451 with respect to the penetration direction D1. That is, the image forming apparatus 1 includes the first movement restricting portion 442 which is disposed on a downstream side of the holding portion 454 with respect to the penetration direction D1 and also restricts the nut 460 which is held by the holding portion 454 from moving in the penetration direction D1.

As shown in part (c) of FIG. 12, the bolt 470 is an example of an engaging member, and includes a male threaded portion 470a and a head portion 470b. The male threaded portion 470a is an example of a through shaft and penetrates the first through hole 441 and the second through hole 455, and screws in the nut 460. In the embodiment, a fastening direction of the bolt 470 and the nut 460 is in the Y direction, which coincides with a mounting direction in which the nut 460 is mounted to the holding portion 454. The head portion 470b is an example of a large diameter portion, is provided with a larger diameter than the male threaded portion 470a, and sandwiches the exterior panel 401a and the abutment portion 452a with the nut 460 in the Y direction. That is, the bolt 470 is inserted from the upstream side with respect to the penetration direction D1 into the first through hole 441 and the second through hole 455, and sandwiches the exterior panel 401a and the abutment portion 452 between itself and the nut 460 and fastens the image forming apparatus 1 to the first feeding apparatus 100.

The male threaded portion 470a penetrates the first through hole 441 and the second through hole 455, and is fastened to the nut 460 by screwing, thereby the image forming apparatus 1 and the first feeding apparatus 100 are fastened and fixed. As shown in part (c) of FIG. 12, an outer periphery of the male threaded portion 470a of the bolt 470 and the first through hole 441 are in a fitted relationship, thereby, it prevents play of the image forming apparatus 1 and the first feeding apparatus 100 in the X direction and the Z direction, which are fixed.

The opening 451 opens toward a downstream side in an insertion direction (penetration direction D1) of the bolt 470 with respect to the top surface protruding portion 450. A force of separating the image forming apparatus 1 from the first feeding apparatus 100 in directions other than the Y direction is received by the nut 460 and the bolt 470, and is also received by a frictional force which is generated at a contact surface between the exterior panel 401a and the abutment portion 452 via the nut 460 and the bolt 470. The nut 460 is held by the circular peripheral surface portion 458 in the X direction and the Z direction and is held by the abutment portion 452 in the Y direction. That is, the holding portion 454 restricts the nut 460 from moving in an intersecting direction (for example, the X direction or the Z direction) which intersects the Y direction. Therefore, the nut 460 is positioned and held against forces other than those in the Y direction which separate the image forming apparatus 1 from the first feeding apparatus 100. By the configuration which is described above, while a simple configuration and a space saving design is realized, it is possible to maintain a high fixing force of the bolt 470 against external forces in the directions which separate the image forming apparatus 1 from the first feeding apparatus 100.

Here, when inserting the bolt 470, a force may act to push the nut 460 toward a downstream side of the insertion direction of the bolt 470. At this time, it is expected that the pushing force which applied by an operator is greater than a force which suppress disengagement of the nut 460 by the second movement restricting portion 457. On the other hand, when the bolt 470 is fastened, as shown in part (c) of FIG. 12, since the image forming apparatus 1 is mounted, the nut 460 abuts against the first movement restricting portion 442 and is restricted from moving in the penetration direction D1. As a result , it is possible to prevents the nut 460 from unintentionally falling out of the holding portion 454. After the nut 460 moves to the downstream side of the insertion direction of the bolt 470 and abuts the first movement restricting portion 442, when the bolt 470 engages with the nut 460, the nut 460 is pulled to an upstream side of the insertion direction of the bolt 470 and abuts the abutment portion 452. With this configuration, a position of the nut 460 in an opposite direction to the penetration direction D1 is held at a position in which the nut 460 abuts against the abutment portion 452.

When it becomes necessary to detach the nut 460 from the first feeding apparatus 100, the bolt 470 is removed and the image forming apparatus 1 is removed upward from the first feeding apparatus 100. As a result, it is possible to detach the nut 460 by applying a force which pushes the nut 460 to a downstream side of the insertion direction of the bolt 470, since the opening 451 is exposed.

As described above, according to the embodiment, the opening 451 is formed so that the nut 460 is attachable to and detachable from the opening 451 in the case in which the engagement of the nut 460 and the bolt 470 is released and connection of the image forming apparatus 1 and the first feeding apparatus 100 is released. As a result, it is possible to more easily replace the nut 460 from the holding portion 454, compared to the case that the opening 451 faces in the direction which intersects the penetration direction D1.

Further, according to the embodiment, the bolt 470 fastens the image forming apparatus 1 and the first feeding apparatus 100 by penetrating the first through hole 441 and the second through hole 455 in the same direction as the Y direction in which the nut 460 is mounted on the holding portion 454. Further, the holding portion 454 restricts the nut 460 from moving in the intersecting direction which intersects in the Y direction. As a result, the nut 460 is positioned and held against forces other than those in the Y direction which separate the image forming apparatus 1 from the first feeding apparatus 100. Further, since the nut 460 is held so that it is attachable to and detachable from the holding portion 454, it is not necessary to increase wall thickness and reinforce the structure in holding portion 454 such as the insert nut. As a result, in the image forming system 300 which applies the bolt 470 and the nut 460 to fasten the two units, it is possible to improve the fastening force between the two units without increasing the size.

Further, according to the embodiment, the nut 460 abuts against the first movement restricting portion 442 and is restricted from moving in the penetration direction D1. As a result, when the bolt 470 is fastened to the nut 460, it is possible to prevents the nut 460 from unintentionally falling out of the holding portion 454.

Further, according to the embodiment, the second movement restricting portion 457 of the holding portion 454 is engaged with the engagement groove 460c of the nut 460. Therefore, it is possible to prevent the nut 460 from falling unintentionally, in a case that the first feeding apparatus 100 is tilted, etc., while the image forming apparatus 1 is not mounted on the first feeding apparatus 100. Further, when mounting the nut 460 on the holding portion 454, press-fitting is not required, so it is possible to assemble with a small force.

### Fifth embodiment

Next, a fifth embodiment of the present disclosure will be specifically described with reference to from FIG. 13 through part (c) of FIG. 15. In the embodiment, a configuration according to the embodiment differs from the first embodiment in that the fixing unit 10 is applied as an example of the image forming apparatus, and the main assembly frame member 30 of the image forming apparatus 1 is applied as an example of a sheet conveying apparatus. However, other configurations are the same as those of the first embodiment, and therefore, the same reference numerals will be used and detailed description will be omitted. Further, an engagement configuration between the nut 560 and the bolt 570 may apply any of the engagement configurations which are described in from the first embodiment through the fourth embodiment, therefore, detailed descriptions will be omitted in the embodiment.

### Main assembly frame member

FIG. 13 is a perspective view of the main assembly frame member 30 of the image forming apparatus, as viewed from an upper rear side. The main assembly frame member 30 is an example of the sheet conveying apparatus and an example of a frame which supports the fixing unit 10. The fixing unit 10, which fixes the toner image which is formed on the sheet S, is supported by the main assembly frame member 30, however, the fixing unit 10 is configured to be removable so that the user can remove it in a case that the sheet is jammed during a print job of the image forming apparatus 1, for example. In a state which is shown in FIG. 13, the fixing unit 10 is not mounted. The main assembly frame member 30 includes a rear surface protruding portion 550a on its upper right side, a rear surface protruding portion 550b on its upper left side, a rear surface protruding portion 550c on its lower right side, and a rear surface protruding portion 550d on its lower left side. The rear surface protruding portions from 550a through 550d are formed so as to protrude rearward from a rear surface of the main assembly frame member 30. The first feeding apparatus 100 includes the positioning pin 124a on the front right side, the positioning pin 124b on the front left side, the positioning pin 124c on the rear right side, and the positioning pin 124d on the rear left side. The positioning pins from 124a through 124d are formed so as to protrude upward from the top surface.

### Joint portion between the main assembly frame member and the fixing unit

Next, the rear surface protruding portions from 550a through 550d of the main assembly frame member 30 will be described with reference to from part (a) through part (c) of FIG. 14. From part (a) through part (c) of FIG. 14 are perspective views of the rear surface protruding portion 550a of the main assembly frame member 30, as viewed from the inside of the main assembly frame member 30. Part (a) of FIG. 14 is a view showing the rear surface protruding portion 550a of the main assembly frame member 30 alone, part (b) of FIG. 14 is a view showing a state before the nut 560 is fitted into the rear surface protruding portion 550a, and part (c) of FIG. 14 is a view showing a state after the nut 560 is fitted into the rear surface protruding portion 550a. As the rear surface protruding portions from 550a through 550d are configured in the same manner, in the following, only the rear surface protruding portion 550a will be described, and descriptions of the rear surface protruding portions from 550b through 550d will be omitted.

As shown in from part (a) through part (c) of FIG. 14, the rear surface protruding portion 550a includes an abutment portion 552 and a holding portion 554. The abutment portion 552 includes an abutment surface which is opposed to the inner side (central side) of the main assembly frame member 30 in the Y direction, and a second through hole 555 which penetrates in the Y direction. That is, the main assembly frame member 30 includes the abutment portion 552 in which the second through hole 555 is formed, and the holding portion 554 which is provided adjacent to the abutment portion 552.

The holding portion 554 includes an opening 551 which is open toward the inner side (central side) of the main assembly frame member 30 in the Y direction. The nut 560 is fitted into the opening 551. That is, the holding portion 554 is an example of the second accommodating portion, and internally accommodates the nut 560. The nut 560 is mounted and held in a mounting direction which is parallel to the holding portion 554 in the Y direction.

The nut 560 is mounted and held in a direction which is an opposite direction to the penetration direction D1 with respect to the holding portion 454. An outer peripheral surface of the nut 560 includes an arc surface 560a about the axis as viewed in the Y direction and a chamfered portion 560b extending in a straight line. That is, the arc surface 560a forms a circular peripheral surface, and the chamfered portion 560b forms a flat surface. The nut 560 includes a through hole with a cross-sectional circular shape about the axis, and a female threaded portion is formed on its inner peripheral surface. The nut 560 is positioned in the opposite direction of the penetration direction D1 by abutting against the abutment portion 552. The nut 560 is held attachable to and detachable from the holding portion 554.

The holding portion 554 includes an circular peripheral surface portion 558 which is an inner peripheral surface about the axis extending in the Y direction and a rotation restricting portion 553 which restricts rotation of the nut 560 about the axis extending in the Y direction. The rotation restricting portion 553 is configured of a plane which is formed along the chamfered portion 560b of the nut 560. By mounting the nut 560 onto the holding portion 554, the chamfered portion 560b of the nut 560 is in surface contact with the rotation restricting portion 553 and the rotation of the nut 560 is restricted. The arc surface 560a of the nut 560 is fixed in the X direction and the Z direction by being in surface contact with the circular peripheral surface portion 558 of the holding portion 554. As a result, the nut 560 is positioned in the X direction, the Z direction, and the rotational direction, when the nut 560 is held by the holding portion 554. In the embodiment, the nut 560 and the holding portion 554 are detachably held in a fitted relationship by press-fitting.

### Connection between the main assembly frame member and the fixing unit

Next, an operation of mounting the fixing unit 10 on a rear portion of the main assembly frame member 30 will be described with reference to from part (a) through part (c) of FIG. 15. From part (a) through part (c) of FIG. 15 are all perspective views of the fixing unit 10 while mounting onto the main assembly frame member 30, as viewed from an upper rear side. Part (a) of FIG. 15 shows a state before the fixing unit 10 is mounted on the rear portion of the main assembly frame member 30, and part (b) of FIG. 8 shows a state after the fixing unit 10 is mounted on the rear portion of the main assembly frame member 30 and before the bolt 570 is screwed. Furthermore, part (c) of FIG. 15 shows a state while the fixing unit 10 and the main assembly frame member 30 are fastened together by the bolt 570.

As shown in part (a) of FIG. 15, the fixing unit 10 includes side end cases 10a at both end portions in the Y direction. In the side end case 10a, four of first through holes 541 which penetrate in the Y direction are formed. That is, the image forming apparatus 1 includes the side end case 10a, which is an example of a first hole portion in which the first through hole 541 is formed. The first through holes 541 are formed at positions overlapping the rear surface protruding portions from 550a through 550d of the main assembly frame member 30 in the Y direction, when the fixing unit 10 is mounted on the main assembly frame member 30. When the fixing unit 10 is mounted onto the main assembly frame member 30, the rear surface protruding portions from 550a through 550d of the main assembly frame member 30 are inserted into unshown recessed portions of the side end cases 10a of the fixing unit 10. The first through holes 541 which are provided with the fixing unit 10 extend to the rear surface protruding portions from 550a through 550d. That is, the rear surface protruding portions from 550a through 550d are examples of accommodated portions, and are accommodated inside the unshown recessed portions, respectively, and the second through holes, which penetrate in the Y direction, respectively, are formed.

The bolt 570 is an example of an engaging member, and includes a male threaded portion and a head portion. A configuration of the bolt 570 is the same as that of the first embodiment, and therefore, detailed descriptions will be omitted in the embodiment. The bolt 570 is inserted into the first through hole 541 and the second through hole 555 along the Y direction, sandwiches the side end case 10a and the abutment portion 552 between itself and the nut 560, and connects the fixing unit 10 and the main assembly frame member 30 by fastening.

Further, in the embodiment, the head portion includes a gripping portion and is configured so that an operator can rotate the bolt 570 without using a tool. As a result, the fixing unit 10 is attachable to and detachable from the main assembly frame member 30 by the operator without using a tool such as a driver. The operator can detach the bolt 570 by rotating the gripping portion in a direction opposite to a tightening direction, and easily detach the fixing unit 10 from the main assembly frame member 30, and when the fixing unit 10 is removed, it is possible to easily detach the nut 560 from the opening 551.

As described above, according to the embodiment, the opening 551 is formed so that the nut 560 is attachable to and detachable from the opening 551 in a case in which the engagement of the nut 560 and the bolt 570 is released and the connection of the fixing unit 10 and the main assembly frame member 30 is released. As a result, it is possible to more easily replace the nut 560 from the holding portion 554, compared to the case that the opening 551 faces in the direction which intersects the penetration direction D1.

Further, according to the embodiment, the bolt 570 fastens the fixing unit 10 and the main assembly frame member 30 by penetrating the first through hole 541 and the second through hole 555 in the same direction as the Y direction in which the nut 560 is mounted on the holding portion 554. Further, the holding portion 554 restricts the nut 560 from moving in the intersecting direction which intersects in the Y direction. As a result, the nut 560 is positioned and held against forces other than those in the Y direction which separate the fixing unit 10 from the main assembly frame member 30. Further, since the nut 560 is held so that it is attachable to and detachable from the holding portion 554, it is not necessary to increase wall thickness and reinforce the structure in holding portion 554 such as the insert nut. As a result, in the image forming system 300 which applies the bolt 570 and the nut 560 to fasten the two units, it is possible to improve the fastening force between the two units without increasing the size.

Further, in the embodiment, the head portion of the bolt 570 includes the gripping portion and is configured so that the operator can rotate the bolt 570 without using the tool. As a result, the fixing unit 10 is attachable to and detachable from the main assembly frame member 30 by the operator without using a tool such as a driver.

In the embodiments which are described above, a case, that the engaging member is an integral member which is configured of the through shaft and the large diameter portion, is described, however, it is not limited to this. For example, the through shaft may be a male threaded shaft, and the large diameter portion may be configured of a nut of a separate member which is screwed with the through shaft.

Further, in the embodiments which are described above, the cases are described in which the image forming apparatus and sheet conveying device are configured to include the image forming apparatus 1, the first feeding apparatus 100, the second feeding apparatus 200, the fixing unit 10, and the main assembly frame member 30, etc., however, it is not limited to these configurations. That is, it is possible to apply to appropriate portions in the image forming system 300.

Further, in the embodiments which are described above, the respective configurations may also be combined with one another. For example, the engaging portion in each embodiment may be either a bolt or a pin member, and the nut in each embodiment may be either a nut or a cylindrical member. Further, the nut may be either a case that it includes a female threaded portion or a case that it does not include the female threaded portion and the female threaded portion is formed by the bolt. Furthermore, the rotation regulating portion and the movement restricting portion may be combined with each other.

According to the present disclosure, it is possible to easily replace the nut from the accommodating portion.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068392 filed on Apr. 17, 2025, which is hereby incorporated by reference herein in its entirety.

What is claimed is:

1. An image forming system comprising:
an image forming apparatus;
a sheet conveying apparatus to be connected to the image forming apparatus;
a nut; and
an engaging member to be engaged with the nut,
wherein the image forming apparatus is provided with a first accommodating portion in which a first through hole is formed,
wherein the sheet conveying apparatus is provided with an accommodated portion configured to be accommodated inside the first accommodating portion and to include a second accommodating portion for accommodating the nut thereinside,
wherein the engaging member is engaged with the nut in a state in which the engaging member is inserted into both the first through hole and a second through hole formed in the accommodated portion,
wherein a downstream end of the second accommodating portion forms an opening in a penetration direction from the first through hole toward the second through hole, and
wherein the opening is formed so that the nut is attachable to and detachable from the opening in a case in which engagement of the nut and the engaging member is released and connection of the image forming apparatus and the sheet conveying apparatus is released.

2. The image forming system according to claim 1, wherein as viewed in the penetration direction, an entire area of the nut is inside an area of the opening.

3. The image forming system according to claim 1, wherein the image forming apparatus includes a first movement restricting portion disposed downstream of the second accommodating portion in the penetration direction and configured to restrict movement of the nut accommodated in the second accommodating portion toward downstream in the penetration direction.

4. The image forming system according to claim 3, wherein the engaging member includes a penetration shaft configured to penetrate the first through hole and the second through hole, and a large diameter portion formed with a larger diameter than the penetration shaft and configured to sandwich the first accommodating portion and the accommodated portion together with the nut in the penetration direction, and
wherein the first movement restricting portion includes a hole portion where the penetration shaft, which projects from the nut to downstream in the penetration direction, enters.

5. The image forming system according to claim 1, wherein the sheet conveying apparatus includes a second movement restricting portion disposed downstream of the second through hole in the penetration direction and configured to restrict movement of the nut accommodated in the second accommodating portion toward downstream in the penetration direction.

6. The image forming system according to claim 5, wherein the second movement restricting portion is provided in the second accommodating portion, and
wherein the nut includes an engaged portion configured to be engaged with the second movement restricting portion in a state of being attached to the second accommodating portion.

7. The image forming system according to claim 1, wherein the second accommodating portion includes a rotation restricting portion configured to restrict rotation of the nut about an axis extending in the penetration direction.

8. The image forming system according to claim 7, wherein as viewed in the penetration direction, the nut has an outer shape of a polygonal shape, and
wherein the rotation restricting portion includes a plurality of planes along the outer shape of the nut.

9. The image forming system according to claim 7, wherein the nut includes a cylindrical portion including an outer peripheral surface about the axis as viewed in the penetration direction and a projecting portion projecting from the outer peripheral surface of the cylindrical portion in a direction away from the axis, and
wherein the rotation restricting portion is a groove portion formed along the projecting portion.

10. The image forming system according to claim 9, wherein the second accommodating portion includes a plurality of ribs holding the outer peripheral surface of the cylindrical portion.

11. The image forming system according to claim 7, wherein an outer peripheral surface of the nut includes an arc surface about the axis as viewed in the penetration direction and a chamfered portion extending in a straight line, and
wherein the rotation restricting portion is a plane formed along the chamfered portion.

12. The image forming system according to claim 1, wherein the engaging member is screwed with the nut.

13. The image forming system according to claim 1, wherein the engaging member is pressed into the nut.

14. The image forming system according to claim 1, wherein the image forming apparatus includes an image forming portion configured to form an image on a sheet, and
wherein the sheet conveying apparatus is a sheet supplying portion configured to supply the sheet to the image forming portion.

15. The image forming system according to claim 1, wherein the image forming apparatus includes an image forming portion configured to form an image on a sheet, and a first sheet supplying portion configured to supply the sheet toward the image forming portion, and
wherein the sheet conveying apparatus is a second sheet supplying portion configured to supply the sheet to the image forming portion via the first sheet supplying portion.

16. The image forming system according to claim 1, wherein the image forming apparatus includes a fixing unit configured to fix a toner image formed on a sheet, and
wherein the sheet conveying apparatus includes a frame configured to support the fixing unit.
